(19) United States
(12) Patent Application Publication
(10) Pub. No.: US 2025/0214390 A1
(43) Pub. Date: Jul. 3, 2025

(54) THERMAL MANAGEMENT SYSTEM FOR ELECTRIC VEHICLE

(71) Applicant: INZICONTROLS CO., LTD, Siheung-si (KR)

(72) Inventors: Ji Hoon KANG, Siheung-si (KR); Hee Hwa JEONG, Siheung-si (KR); Seung Chan HA, Siheung-si (KR); Seong Hyeon KIM, Siheung-si (KR)

(73) Assignee: INZICONTROLS CO., LTD, Siheung-si (KR)

(21) Appl. No.: 19/087,711

(22) Filed: Mar. 24, 2025

Related U.S. Application Data
(63) Continuation of application No. PCT/KR2023/014750, filed on Sep. 26, 2023.

(30) Foreign Application Priority Data
Sep. 30, 2022 (KR) 10-2022-0125488
Sep. 20, 2023 (KR) 10-2023-0125583

(51) Int. Cl. B60H 1/00

(52) U.S. Cl. CPC B60H 1/00278; B60H 1/00342; B60H 1/00392; B60H 1/00899; B60H 2001/00307

(57) ABSTRACT

A thermal management system for an electric vehicle includes a heat pump unit in which heat is released and absorbed due to the heat dissipation and condensation heat of the refrigerant; a refrigerant-coolant heat exchanger having one side thermally connected to the heat pump unit such that it is cooled or heated by the refrigerant of the heat pump unit; and a thermal management unit thermally connected to the other side of the refrigerant-coolant heat exchanger and configured to regulate the thermal of at least one of a battery pack and an electrical component module by using a coolant that has been cooled or heated by the refrigerant-coolant heat exchanger.

### CROSS REFERENCE TO RELATED APPLICATIONS

This application is a Bypass Continuation of International Application No. PCT/KR2023/014750 filed Sep. 26, 2023, claiming priority based on Korean Patent Application No. 10-2022-0125488 filed Sep. 30, 2022 and Korean Patent Application No. 10-2023-0125583 filed Sep. 20, 2023.

### TECHNICAL FIELD

The present invention relates to a thermal management system for electric vehicle, and more specifically, to a thermal management system that effectively regulates the thermal of a battery pack, an electrical component module, and a heat exchanger of an air-conditioning system by using cooling water that is heated or cooled by a refrigerant of a heat pump unit. Furthermore, the system is configured to adjust the thermal management mode of the battery pack, the electrical component module, and the heat exchanger of the air-conditioning system by modifying the flow patterns of the refrigerant and the cooling water.

### BACKGROUND ART

Generally, an electric vehicle is structured to be driven by power output from a motor of an electrical component module, with electricity supplied from a battery pack. As a result, compared to conventional vehicles powered by an internal combustion engine, electric vehicles produce no carbon dioxide emissions and generate less noise, making them highly regarded as environmentally friendly vehicles.

As a key component of an electric vehicle, technologies related to the battery pack are being actively researched. In particular, recent research has been intensively focused on reducing the weight and size of battery packs, shortening charging times, and improving safety.

The battery pack of an electric vehicle must operate within an optimal thermal environment to ensure maximum performance and longevity. However, due to the heat generated inside the battery pack during vehicle operation and external thermal fluctuations, maintaining the battery pack within the optimal thermal range is highly challenging.

To address this issue, conventional electric vehicles often incorporate an additional heating and cooling system dedicated to controlling the thermal of the battery pack. This battery pack thermal control system is installed and operated separately from the heating and cooling system used for conditioning the cabin interior of the vehicle. Consequently, conventional electric vehicles employ two independent heating and cooling systems: one for the cabin interior and the other for managing the thermal of the battery pack.

Operating two separate heating and cooling systems independently enables the battery pack to maintain its optimal operating thermal efficiently. However, this approach significantly increases the overall power consumption of the electric vehicle, leading to a substantial reduction in energy efficiency. As a result, the driving range of an electric vehicle per charge is considerably reduced.

To overcome these challenges, there is an urgent need for the development of technologies that integrate the thermal management system of the air-conditioning system, the battery pack, and the electrical component module in an electric vehicle.

### DISCLOSURE

### Technical Problem

An embodiment of the present invention provides a thermal management system for an electric vehicle that enables the thermal management unit to appropriately regulate the thermal of a battery pack, an electrical component module, and a heat exchanger of an air-conditioning system by using cooling water that is heated or cooled by a refrigerant of a heat pump unit. Since a separate heating and cooling system is not required, the configuration of the thermal management unit may be simplified, thereby reducing the manufacturing cost and weight of the thermal management system.

Additionally, an embodiment of the present invention provides a thermal management system for an electric vehicle that allows various thermal management modes to be set for the battery pack, the electrical component module, and the heat exchanger of the air-conditioning system by diversely adjusting the flow patterns of the refrigerant in the heat pump unit and the cooling water in the thermal management unit. Accordingly, the system may provide an optimal thermal management mode depending on the driving conditions of the electric vehicle and the surrounding environment.

### Technical Solution

According to an embodiment of the present invention, there is provided a thermal management system for an electric vehicle, comprising: a heat pump unit configured to release and absorb heat based on the heat dissipation and condensation heat of a refrigerant, a refrigerant-to-cooling water heat exchanger having one side thermally connected to the heat pump unit to be cooled or heated by the refrigerant of the heat pump unit, and a thermal management unit thermally connected to the other side of the refrigerant-to-cooling water heat exchanger, the thermal management unit being configured to regulate the thermal of at least one of a battery pack and an electrical component module by using cooling water that is cooled or heated by the refrigerant-to-cooling water heat exchanger.

Preferably, the heat pump unit may comprise: a compressor configured to compress the refrigerant, an expansion valve configured to expand the refrigerant compressed by the compressor, a refrigerant switching valve disposed between the expansion valve and the compressor and configured to selectively switch a flow direction of the refrigerant flowing between the expansion valve and the compressor, and a refrigerant circulation passage configured to circulate the refrigerant along the compressor, the refrigerant switching valve, the expansion valve, and the refrigerant-to-cooling water heat exchanger.

The refrigerant circulation passage may comprise: a first refrigerant passage connecting an outlet of the compressor to a first refrigerant port of the refrigerant switching valve, a second refrigerant passage connecting a second refrigerant port of the refrigerant switching valve to a first inlet/outlet of the expansion valve, a third refrigerant passage connecting a second inlet/outlet of the expansion valve to a third refrigerant port of the refrigerant switching valve, and a fourth refrigerant passage connecting a fourth refrigerant port of the refrigerant switching valve to an inlet of the compressor.

The refrigerant-to-cooling water heat exchanger may comprise: a first refrigerant-to-cooling water heat exchanger having one side connected to the second refrigerant passage, and a second refrigerant-to-cooling water heat exchanger having one side connected to the third refrigerant passage.

In this case, one of the first refrigerant-to-cooling water heat exchanger and the second refrigerant-to-cooling water heat exchanger may be heated by the refrigerant, while the other one of the first refrigerant-to-cooling water heat exchanger and the second refrigerant-to-cooling water heat exchanger may be cooled by the refrigerant.

Preferably, the refrigerant switching valve may be provided as a four-way switching valve having a first refrigerant port, a second refrigerant port, a third refrigerant port, and a fourth refrigerant port.

Preferably, the heat pump unit may be configured to operate in one of a first refrigerant flow mode or a second refrigerant flow mode according to an operation pattern of the refrigerant switching valve.

In the first refrigerant flow mode, the first refrigerant-to-cooling water heat exchanger may receive the refrigerant compressed by the compressor, and the second refrigerant-to-cooling water heat exchanger may receive the refrigerant expanded by the expansion valve.

In the second refrigerant flow mode, the first refrigerant-to-cooling water heat exchanger may receive the refrigerant expanded by the expansion valve, and the second refrigerant-to-cooling water heat exchanger may receive the refrigerant compressed by the compressor.

Preferably, the refrigerant switching valve may further comprise a first internal passage configured to selectively connect the first refrigerant port to either the second refrigerant port or the third refrigerant port, and a second internal passage configured to selectively connect the fourth refrigerant port to either the second refrigerant port or the third refrigerant port.

In the first refrigerant flow mode, the first internal passage may connect the first refrigerant port to the second refrigerant port, while the second internal passage may connect the fourth refrigerant port to the third refrigerant port.

In the second refrigerant flow mode, the first internal passage may connect the first refrigerant port to the third refrigerant port, while the second internal passage may connect the fourth refrigerant port to the second refrigerant port.

Preferably, the expansion valve may comprise a first inlet/outlet connected to the second refrigerant passage, a second inlet/outlet connected to the third refrigerant passage, and a third inlet/outlet connected to the fourth refrigerant passage.

The first inlet/outlet and the second inlet/outlet may be continuously open, and the third inlet/outlet may be selectively opened or closed to bypass a portion of the refrigerant introduced into the expansion valve to the fourth refrigerant passage.

Preferably, the heat pump unit may further comprise: an accumulator disposed on the fourth refrigerant passage and configured to maintain a constant pressure of the refrigerant flowing into an inlet of the compressor, a first pressure sensor disposed on the first refrigerant passage and configured to measure a pressure of the refrigerant discharged from an outlet of the compressor, and a second pressure sensor disposed on the fourth refrigerant passage and configured to measure a pressure of the refrigerant flowing into the inlet of the compressor.

Preferably, the thermal management system for an electric vehicle according to an embodiment of the present invention may further comprise: a radiator configured to exchange heat between the cooling water and external air, and a cooling water-to-air heat exchanger configured to exchange heat between the cooling water and interior air of the electric vehicle.

The cooling water-to-air heat exchanger may comprise: a first cooling water-to-air heat exchanger and a second cooling water-to-air heat exchanger, which are provided to independently control the interior air.

Preferably, the thermal management unit may comprise: a cooling water pump configured to pump the cooling water, a cooling water heater configured to selectively heat the cooling water, a cooling water circulation passage configured to circulate the cooling water along the cooling water pump, the cooling water heater, the refrigerant-to-cooling water heat exchanger, the battery pack, the electrical component module, the radiator, and the cooling water-to-air heat exchanger, and a cooling water control valve disposed on the cooling water circulation passage and configured to change a flow pattern of the cooling water flowing along the cooling water circulation passage, the cooling water control valve being operable in a plurality of operation patterns to regulate thermals of the battery pack, the electrical component module, and the cooling water-to-air heat exchanger.

The cooling water circulation passage may comprise: a first cooling water passage configured to connect a first cooling water port and a second cooling water port of the cooling water control valve and to be connected to a second side of the first refrigerant-to-cooling water heat exchanger, a second cooling water passage configured to connect a third cooling water port and a fourth cooling water port of the cooling water control valve and to be connected to a second side of the second refrigerant-to-cooling water heat exchanger, a third cooling water passage configured to connect a fifth cooling water port and a sixth cooling water port of the cooling water control valve and to be connected to the battery pack and the cooling water heater, a fourth cooling water passage configured to connect a seventh cooling water port and an eighth cooling water port of the cooling water control valve and to be connected to the electrical component module, a fifth cooling water passage configured to connect a ninth cooling water port and a tenth cooling water port of the cooling water control valve and to be connected to the first cooling water-to-air heat exchanger, a sixth cooling water passage configured to connect an eleventh cooling water port and a twelfth cooling water port of the cooling water control valve and to be connected to the second cooling water-to-air heat exchanger, and a seventh cooling water passage configured to connect a thirteenth cooling water port and a fourteenth cooling water port of the cooling water control valve and to be connected to the radiator.

Preferably, the thermal management unit may further comprise: a first thermal sensor disposed on the first cooling water passage and configured to measure a thermal of the cooling water flowing from the first refrigerant-to-cooling water heat exchanger to the second cooling water port, and a second thermal sensor disposed on the second cooling water passage and configured to measure a thermal of the cooling water flowing from the second refrigerant-to-cooling water heat exchanger to the fourth cooling water port.

Preferably, the cooling water pump may comprise: a first cooling water pump disposed on the second cooling water passage between the second refrigerant-to-cooling water heat exchanger and the fourth cooling water port and configured to pump the cooling water to the fourth cooling water port, a second cooling water pump disposed on the third cooling water passage between the fifth cooling water port and the battery pack and configured to pump the cooling water to the battery pack, a third cooling water pump disposed on the fourth cooling water passage between the seventh cooling water port and the electrical component module and configured to pump the cooling water to the electrical component module, and a fourth cooling water pump disposed on the fifth cooling water passage between the ninth cooling water port and the first cooling water-to-air heat exchanger and configured to pump the cooling water to the first cooling water-to-air heat exchanger.

Preferably, the cooling water control valve may be provided as a 14-way control valve having first to fourteenth cooling water ports.

The thermal management unit may be configured to operate in a plurality of thermal management modes according to the operation patterns of the refrigerant switching valve and the cooling water control valve to regulate the thermals of the battery pack, the electrical component module, and the cooling water-to-air heat exchanger.

Preferably, the thermal management modes may be classified into a first thermal management mode, a second thermal management mode, a third thermal management mode, and a fourth thermal management mode according to the heat exchange pattern between the refrigerant and the cooling water in the first refrigerant-to-cooling water heat exchanger.

In the first thermal management mode, the heat pump unit may operate in the first refrigerant flow mode, and the cooling water control valve may operate to flow low-thermal cooling water along the first cooling water passage, heat the cooling water in the first refrigerant-to-cooling water heat exchanger, and then deliver the heated cooling water to the battery pack and the electrical component module.

In the second thermal management mode, the heat pump unit may operate in the first refrigerant flow mode, and the cooling water control valve may operate to flow medium-thermal cooling water along the first cooling water passage, heat the cooling water in the first refrigerant-to-cooling water heat exchanger, and then deliver the heated cooling water to the battery pack.

In the third thermal management mode, the heat pump unit may operate in the second refrigerant flow mode, and the cooling water control valve may operate to flow medium-thermal cooling water along the first cooling water passage, cool the cooling water in the first refrigerant-to-cooling water heat exchanger, and then deliver the cooled cooling water to the battery pack and at least one of the electrical component module and the first cooling water-to-air heat exchanger.

In the fourth thermal management mode, the heat pump unit may operate in the second refrigerant flow mode, and the cooling water control valve may operate to flow medium-low-thermal cooling water along the first cooling water passage, cool the cooling water in the first refrigerant-to-cooling water heat exchanger, and then deliver the cooled cooling water to the battery pack.

Preferably, the first thermal management mode may include an ambient air heat absorption heating mode, in which the cooling water heated in the first refrigerant-to-cooling water heat exchanger is used to increase the thermals of the battery pack, the first cooling water-to-air heat exchanger, and the electrical component module under environmental conditions where the ambient air thermal is higher than the evaporation thermal of the refrigerant.

At this time, the cooling water control valve may open the first and second cooling water ports to allow the cooling water to flow through the first cooling water passage, open the fifth and sixth cooling water ports to receive the cooling water introduced into the second cooling water port and deliver it to the fifth cooling water port, thereby allowing the cooling water to flow through the third cooling water passage, open the ninth and tenth cooling water ports to receive the cooling water introduced into the second cooling water port and deliver it to the ninth cooling water port, thereby allowing the cooling water to flow through the fifth cooling water passage, and open the seventh and eighth cooling water ports to receive the cooling water introduced into the sixth and tenth cooling water ports and deliver it to the seventh cooling water port, thereby allowing the cooling water to flow through the fourth cooling water passage, and then deliver the cooling water introduced into the eighth cooling water port to the first cooling water port.

Additionally, the cooling water control valve may open the third and fourth cooling water ports to allow the cooling water to flow through the second cooling water passage, open the thirteenth and fourteenth cooling water ports to receive the cooling water introduced into the fourth cooling water port and deliver it to the thirteenth cooling water port, thereby allowing the cooling water to flow through the seventh cooling water passage, and then deliver the cooling water introduced into the fourteenth cooling water port to the third cooling water port.

Preferably, the first thermal management mode may include an inefficient heating mode, in which the cooling water heated in the first refrigerant-to-cooling water heat exchanger is used to increase the thermals of the battery pack, the first cooling water-to-air heat exchanger, and the electrical component module in extreme cold environmental conditions where ambient air heat absorption is not possible, and the heated cooling water is subsequently cooled in the second refrigerant-to-cooling water heat exchanger.

At this time, the cooling water control valve may open the first and second cooling water ports to allow the cooling water to flow through the first cooling water passage, open the fifth and sixth cooling water ports to receive the cooling water introduced into the second cooling water port and deliver it to the fifth cooling water port, thereby allowing the cooling water to flow through the third cooling water passage, open the ninth and tenth cooling water ports to receive the cooling water introduced into the second cooling water port and deliver it to the ninth cooling water port, thereby allowing the cooling water to flow through the fifth cooling water passage, open the seventh and eighth cooling water ports to receive the cooling water introduced into the sixth and tenth cooling water ports and deliver it to the seventh cooling water port, thereby allowing the cooling water to flow through the fourth cooling water passage, open the third and fourth cooling water ports to receive the cooling water introduced into the eighth cooling water port and deliver it to the third cooling water port, thereby allowing the cooling water to flow through the second cooling water passage, and then deliver the cooling water introduced into the fourth cooling water port to the first cooling water port.

Preferably, the first thermal management mode may include an inefficient heating and drying mode, in which, in the inefficient heating mode, the third inlet/outlet of the expansion valve is additionally opened to bypass a portion of the refrigerant introduced into the expansion valve to the fourth refrigerant passage.

Preferably, the first thermal management mode may include an ambient heat absorption battery warm-up mode, in which the cooling water heated by the first refrigerant-to-cooling water heat exchanger is used to increase the thermals of the battery pack and the electrical component module under environmental conditions where the operation of the air-conditioning system is unnecessary.

At this time, the cooling water control valve may open the first and second cooling water ports to allow the cooling water to flow through the first cooling water passage, open the fifth and sixth cooling water ports to receive the cooling water introduced into the second cooling water port and deliver it to the fifth cooling water port, thereby allowing the cooling water to flow through the third cooling water passage, open the seventh and eighth cooling water ports to receive the cooling water introduced into the sixth cooling water port and deliver it to the seventh cooling water port, thereby allowing the cooling water to flow through the fourth cooling water passage, and then deliver the cooling water introduced into the eighth cooling water port to the first cooling water port.

Additionally, the cooling water control valve may open the third and fourth cooling water ports to allow the cooling water to flow through the second cooling water passage, open the thirteenth and fourteenth cooling water ports to receive the cooling water introduced into the fourth cooling water port and deliver it to the thirteenth cooling water port, thereby allowing the cooling water to flow through the seventh cooling water passage, and then deliver the cooling water introduced into the fourteenth cooling water port to the third cooling water port.

Preferably, the first thermal management mode may include an inefficient battery warm-up mode, in which the cooling water heated by the first refrigerant-to-cooling water heat exchanger is used to increase the thermals of the battery pack and the electrical component module under environmental conditions where the operation of the air-conditioning system is unnecessary, and the heated cooling water is subsequently cooled in the second refrigerant-to-cooling water heat exchanger.

At this time, the cooling water control valve may open the first and second cooling water ports to allow the cooling water to flow through the first cooling water passage, open the fifth and sixth cooling water ports to receive the cooling water introduced into the second cooling water port and deliver it to the fifth cooling water port, thereby allowing the cooling water to flow through the third cooling water passage, open the seventh and eighth cooling water ports to receive the cooling water introduced into the sixth cooling water port and deliver it to the seventh cooling water port, thereby allowing the cooling water to flow through the fourth cooling water passage, open the third and fourth cooling water ports to receive the cooling water introduced into the eighth cooling water port and deliver it to the third cooling water port, thereby allowing the cooling water to flow through the second cooling water passage, and then deliver the cooling water introduced into the fourth cooling water port to the first cooling water port.

Preferably, the first thermal management mode may include an inefficient battery warm-up drying mode, in which, in the inefficient battery warm-up mode, the third inlet/outlet of the expansion valve is additionally opened to bypass a portion of the refrigerant introduced into the expansion valve to the fourth refrigerant passage.

Preferably, the second thermal management mode may include a battery heat storage mode, in which, under environmental conditions where an indoor heating source is available in the electric vehicle during winter when the driver is absent, the cooling water heated by the first refrigerant-to-cooling water heat exchanger is used to increase the thermal of the battery pack, and the cooling water cooled by the second refrigerant-to-cooling water heat exchanger is used to lower the thermal of the second cooling water-to-air heat exchanger.

At this time, the cooling water control valve may open the first and second cooling water ports to allow the cooling water to flow through the first cooling water passage, open the fifth and sixth cooling water ports to receive the cooling water introduced into the second cooling water port and deliver it to the fifth cooling water port, thereby allowing the cooling water to flow through the third cooling water passage, and then deliver the cooling water introduced into the sixth cooling water port to the first cooling water port.

Additionally, the cooling water control valve may open the seventh and eighth cooling water ports to allow the cooling water to flow through the fourth cooling water passage, open the thirteenth and fourteenth cooling water ports to receive the cooling water introduced into the eighth cooling water port and deliver it to the thirteenth cooling water port, thereby allowing the cooling water to flow through the seventh cooling water passage, and then deliver the cooling water introduced into the fourteenth cooling water port to the seventh cooling water port.

Additionally, the cooling water control valve may open the third and fourth cooling water ports to allow the cooling water to flow through the second cooling water passage, open the eleventh and twelfth cooling water ports to receive the cooling water introduced into the fourth cooling water port and deliver it to the eleventh cooling water port, thereby allowing the cooling water to flow through the sixth cooling water passage, and then deliver the cooling water introduced into the twelfth cooling water port to the third cooling water port.

Preferably, the third thermal management mode may include a waste heat recovery heating mode, in which, under environmental conditions that require improved indoor heating performance in the electric vehicle in extreme cold conditions, the cooling water cooled by the first refrigerant-to-cooling water heat exchanger is used to lower the thermals of the battery pack and the electrical component module, and the cooling water heated by the second refrigerant-to-cooling water heat exchanger is used to increase the thermal of the second cooling water-to-air heat exchanger.

At this time, the cooling water control valve may open the first and second cooling water ports to allow the cooling water to flow through the first cooling water passage, open the fifth and sixth cooling water ports to receive the cooling water introduced into the second cooling water port and deliver it to the fifth cooling water port, thereby allowing the cooling water to flow through the third cooling water passage, open the seventh and eighth cooling water ports to receive the cooling water introduced into the sixth cooling water port and deliver it to the seventh cooling water port, thereby allowing the cooling water to flow through the fourth cooling water passage, and then deliver the cooling water introduced into the eighth cooling water port to the first cooling water port.

Additionally, the cooling water control valve may open the third and fourth cooling water ports to allow the cooling water to flow through the second cooling water passage, open the eleventh and twelfth cooling water ports to receive the cooling water introduced into the fourth cooling water port and deliver it to the eleventh cooling water port, thereby allowing the cooling water to flow through the sixth cooling water passage, and then deliver the cooling water introduced into the twelfth cooling water port to the third cooling water port.

Preferably, the third thermal management mode may include a defogging mode, in which, under environmental conditions where defogging is required, the cooling water cooled by the first refrigerant-to-cooling water heat exchanger is used to lower the thermals of the battery pack, the first cooling water-to-air heat exchanger, and the electrical component module, while the cooling water heated by the second refrigerant-to-cooling water heat exchanger is used to increase the thermal of the second cooling water-to-air heat exchanger.

The cooling water control valve may open the first and second cooling water ports to allow the cooling water to flow through the first cooling water passage, open the fifth and sixth cooling water ports to receive the cooling water introduced into the second cooling water port and deliver it to the fifth cooling water port, thereby allowing the cooling water to flow through the third cooling water passage, open the ninth and tenth cooling water ports to receive the cooling water introduced into the second cooling water port and deliver it to the ninth cooling water port, thereby allowing the cooling water to flow through the fifth cooling water passage, open the seventh and eighth cooling water ports to receive the cooling water introduced into the sixth and tenth cooling water ports and deliver it to the seventh cooling water port, thereby allowing the cooling water to flow through the fourth cooling water passage, and then deliver the cooling water introduced into the eighth cooling water port to the first cooling water port.

Additionally, the cooling water control valve may open the third and fourth cooling water ports to allow the cooling water to flow through the second cooling water passage, open the eleventh and twelfth cooling water ports to receive the cooling water introduced into the fourth cooling water port and deliver it to the eleventh cooling water port, thereby allowing the cooling water to flow through the sixth cooling water passage, and then deliver the cooling water introduced into the twelfth cooling water port to the third cooling water port.

Preferably, the third thermal management mode may include a defrosting mode, in which, under environmental conditions requiring defrosting of the cooling water-to-air heat exchanger, the cooling water cooled by the first refrigerant-to-cooling water heat exchanger is used to lower the thermals of the battery pack and the electrical component module, while the cooling water heated by the second refrigerant-to-cooling water heat exchanger is used to increase the thermal of the second cooling water-to-air heat exchanger.

At this time, the cooling water control valve may open the first and second cooling water ports to allow the cooling water to flow through the first cooling water passage, open the fifth and sixth cooling water ports to receive the cooling water introduced into the second cooling water port and deliver it to the fifth cooling water port, thereby allowing the cooling water to flow through the third cooling water passage, open the seventh and eighth cooling water ports to receive the cooling water introduced into the sixth cooling water port and deliver it to the seventh cooling water port, thereby allowing the cooling water to flow through the fourth cooling water passage, and then deliver the cooling water introduced into the eighth cooling water port to the first cooling water port.

Additionally, the cooling water control valve may open the third and fourth cooling water ports to allow the cooling water to flow through the second cooling water passage, open the eleventh and twelfth cooling water ports to receive the cooling water introduced into the fourth cooling water port and deliver it to the eleventh cooling water port, thereby allowing the cooling water to flow through the sixth cooling water passage, and then deliver the cooling water introduced into the twelfth cooling water port to the third cooling water port.

Preferably, the third thermal management mode may include a dehumidification mode, in which, under environmental conditions requiring dehumidification of the indoor air of the electric vehicle, the cooling water cooled by the first refrigerant-to-cooling water heat exchanger is used to lower the thermals of the battery pack and the first cooling water-to-air heat exchanger, while the cooling water heated by the second refrigerant-to-cooling water heat exchanger is used to increase the thermal of the second cooling water-to-air heat exchanger.

At this time, the cooling water control valve may open the first and second cooling water ports to allow the cooling water to flow through the first cooling water passage, open the fifth and sixth cooling water ports to receive the cooling water introduced into the second cooling water port and deliver it to the fifth cooling water port, thereby allowing the cooling water to flow through the third cooling water passage, open the ninth and tenth cooling water ports to receive the cooling water introduced into the second cooling water port and deliver it to the ninth cooling water port, thereby allowing the cooling water to flow through the fifth cooling water passage, and then deliver the cooling water introduced into the sixth and tenth cooling water ports to the first cooling water port.

Additionally, the cooling water control valve may open the third and fourth cooling water ports to allow the cooling water to flow through the second cooling water passage, open the eleventh and twelfth cooling water ports to receive the cooling water introduced into the fourth cooling water port and deliver it to the eleventh cooling water port, thereby allowing the cooling water to flow through the sixth cooling water passage, and then deliver the cooling water introduced into the twelfth cooling water port to the third cooling water port.

Preferably, the third thermal management mode may include a battery cooling air-conditioning mode, in which, under environmental conditions requiring cooling of the battery pack and indoor air, the cooling water cooled by the first refrigerant-to-cooling water heat exchanger is used to lower the thermals of the battery pack and the first cooling water-to-air heat exchanger, while the cooling water heated by the second refrigerant-to-cooling water heat exchanger is used to increase the thermal of the electrical component module.

At this time, the cooling water control valve may open the first and second cooling water ports to allow the cooling water to flow through the first cooling water passage, open the fifth and sixth cooling water ports to receive the cooling water introduced into the second cooling water port and deliver it to the fifth cooling water port, thereby allowing the cooling water to flow through the third cooling water passage, open the ninth and tenth cooling water ports to receive the cooling water introduced into the second cooling water port and deliver it to the ninth cooling water port, thereby allowing the cooling water to flow through the fifth cooling water passage, and then deliver the cooling water introduced into the sixth and tenth cooling water ports to the first cooling water port.

Additionally, the cooling water control valve may open the third and fourth cooling water ports to allow the cooling water to flow through the second cooling water passage, open the seventh and eighth cooling water ports to receive the cooling water introduced into the fourth cooling water port and deliver it to the seventh cooling water port, thereby allowing the cooling water to flow through the fourth cooling water passage, and open the thirteenth and fourteenth cooling water ports to receive the cooling water introduced into the eighth cooling water port and deliver it to the thirteenth cooling water port, thereby allowing the cooling water to flow through the seventh cooling water passage, and then deliver the cooling water introduced into the fourteenth cooling water port to the third cooling water port.

Preferably, the third thermal management mode may include an electrical component warm-up cooling mode, in which, under environmental conditions requiring rapid warm-up of the electrical component module, the cooling water cooled by the first refrigerant-to-cooling water heat exchanger is used to lower the thermals of the battery pack and the first cooling water-to-air heat exchanger, while the cooling water heated by the second refrigerant-to-cooling water heat exchanger is used to increase the thermal of the electrical component module.

At this time, the cooling water control valve may open the first and second cooling water ports to allow the cooling water to flow through the first cooling water passage, open the fifth and sixth cooling water ports to receive the cooling water introduced into the second cooling water port and deliver it to the fifth cooling water port, thereby allowing the cooling water to flow through the third cooling water passage, open the ninth and tenth cooling water ports to receive the cooling water introduced into the second cooling water port and deliver it to the ninth cooling water port, thereby allowing the cooling water to flow through the fifth cooling water passage, and then deliver the cooling water introduced into the sixth and tenth cooling water ports to the first cooling water port.

Additionally, the cooling water control valve may open the third and fourth cooling water ports to allow the cooling water to flow through the second cooling water passage, open the seventh and eighth cooling water ports to receive the cooling water introduced into the fourth cooling water port and deliver it to the seventh cooling water port, thereby allowing the cooling water to flow through the fourth cooling water passage, and then deliver the cooling water introduced into the eighth cooling water port to the third cooling water port.

Preferably, the fourth thermal management mode may include a charging cooling mode, in which, under environmental conditions where the battery pack is undergoing high-power charging in the absence of passengers, the cooling water cooled by the first refrigerant-to-cooling water heat exchanger is used to lower the thermal of the battery pack, while the cooling water heated by the second refrigerant-to-cooling water heat exchanger is used to increase the thermal of the electrical component module.

At this time, the cooling water control valve may open the first and second cooling water ports to allow the cooling water to flow through the first cooling water passage, open the fifth and sixth cooling water ports to receive the cooling water introduced into the second cooling water port and deliver it to the fifth cooling water port, thereby allowing the cooling water to flow through the third cooling water passage, and then deliver the cooling water introduced into the sixth cooling water port to the first cooling water port.

Additionally, the cooling water control valve may open the third and fourth cooling water ports to allow the cooling water to flow through the second cooling water passage, open the seventh and eighth cooling water ports to receive the cooling water introduced into the fourth cooling water port and deliver it to the seventh cooling water port, thereby allowing the cooling water to flow through the fourth cooling water passage, and open the thirteenth and fourteenth cooling water ports to receive the cooling water introduced into the eighth cooling water port and deliver it to the thirteenth cooling water port, thereby allowing the cooling water to flow through the seventh cooling water passage, and then deliver the cooling water introduced into the fourteenth cooling water port to the third cooling water port.

### Advantageous Effects

The thermal management system for an electric vehicle according to an embodiment of the present invention utilizes a refrigerant-to-cooling water heat exchanger that exchanges heat between the refrigerant of the heat pump unit and the cooling water of the thermal management unit, thereby heating or cooling the cooling water with the refrigerant. The system is structured to selectively flow the cooling water to the battery pack, the electrical component module, and the cooling water-to-air heat exchanger of the air-conditioning system. Accordingly, the thermal management unit may appropriately regulate the thermals of the battery pack, the electrical component module, and the cooling water-to-air heat exchanger based on the driving conditions of the electric vehicle and the surrounding environment, allowing these components to be conveniently controlled within an integrated system.

Additionally, since the thermal management system for an electric vehicle according to an embodiment of the present invention integrates the thermal regulation functions of the battery pack and the electrical component module with the indoor air-conditioning function of the cooling water-to-air heat exchanger into a single system, a separate heating and cooling system for indoor air-conditioning may be omitted. This simplifies the configuration of the thermal management system and enables the system to be manufactured as a single integrated module, reducing manufacturing costs, weight, and installation space.

Furthermore, the thermal management system for an electric vehicle according to an embodiment of the present invention allows various refrigerant flow modes of the heat pump unit and thermal management modes of the thermal management unit to be set by flexibly adjusting the flow patterns of the refrigerant and the cooling water using the refrigerant switching valve of the heat pump unit and the cooling water control valve of the thermal management unit. As a result, the system operates in an optimal thermal management mode tailored to the driving conditions of the electric vehicle and the surrounding environment, enhancing the thermal regulation performance of the battery pack, the electrical component module, and the cooling water-to-air heat exchanger.

Moreover, since the thermal management system for an electric vehicle according to an embodiment of the present invention utilizes the refrigerant switching valve of the heat pump unit to reverse the flow direction of the refrigerant circulating through the refrigerant circulation passage, the heat exchange pattern between the refrigerant of the heat pump unit and the cooling water of the thermal management unit may be altered depending on the flow direction of the refrigerant circulation passage. This allows for a greater variety of thermal management modes in the thermal management unit.

Additionally, since the thermal management system for an electric vehicle according to an embodiment of the present invention includes a radiator that exchanges heat between the cooling water of the thermal management unit and external air, as well as a cooling water heater that directly heats the cooling water, the system may absorb heat from external air into the cooling water using the radiator or release heat from the cooling water into external air. This further enhances the thermal regulation performance of the thermal management unit.

In summary, the embodiment of the present invention enables the implementation of various thermal management functions, including indoor heating and cooling, battery pack warm-up, electrical component module warm-up, rapid charging of the battery pack, defogging, defrosting, dehumidification, and waste heat recovery, through the thermal management modes of the thermal management unit.

### DESCRIPTION OF DRAWINGS

FIG. 1 is a configuration diagram illustrating a thermal management system for an electric vehicle according to an embodiment of the present invention.

FIG. 2 is a diagram illustrating an ambient heat absorption heating mode of the first thermal management mode of the thermal management system shown in FIG. 1.

FIG. 3 is a diagram illustrating an inefficient heating mode of the first thermal management mode of the thermal management system shown in FIG. 1.

FIG. 4 is a diagram illustrating an inefficient heating drying mode of the first thermal management mode of the thermal management system shown in FIG. 1.

FIG. 5 is a diagram illustrating an ambient heat absorption battery warm-up mode of the first thermal management mode of the thermal management system shown in FIG. 1.

FIG. 6 is a diagram illustrating an inefficient battery warm-up mode of the first thermal management mode of the thermal management system shown in FIG. 1.

FIG. 7 is a diagram illustrating an inefficient battery warm-up drying mode of the first thermal management mode of the thermal management system shown in FIG. 1.

FIG. 8 is a diagram illustrating a battery heat storage mode of the second thermal management mode of the thermal management system shown in FIG. 1.

FIG. 9 is a diagram illustrating a waste heat recovery heating mode of the third thermal management mode of the thermal management system shown in FIG. 1.

FIG. 10 is a diagram illustrating a defogging mode of the third thermal management mode of the thermal management system shown in FIG. 1.

FIG. 11 is a diagram illustrating a defrosting mode of the third thermal management mode of the thermal management system shown in FIG. 1.

FIG. 12 is a diagram illustrating a battery warm-up followed by dehumidification mode of the third thermal management mode of the thermal management system shown in FIG. 1.

FIG. 13 is a diagram illustrating a battery warm-up followed by battery cooling air-conditioning mode of the third thermal management mode of the thermal management system shown in FIG. 1.

FIG. 14 is a diagram illustrating an electrical component warm-up cooling mode of the third thermal management mode of the thermal management system shown in FIG. 1.

FIG. 15 is a diagram illustrating a charging cooling mode of the fourth thermal management mode of the thermal management system shown in FIG. 1.

FIG. 16 is a diagram illustrating a pre-battery warm-up dehumidification mode of the fourth thermal management mode of the thermal management system shown in FIG. 1.

FIG. 17 is a diagram illustrating a pre-battery warm-up battery cooling air-conditioning mode of the fourth thermal management mode of the thermal management system shown in FIG. 1.

### BEST MODE

The embodiments of the present invention will now be described in detail with reference to the accompanying drawings. However, the present invention is not limited to or restricted by these embodiments. The same reference numerals in the drawings denote the same components.

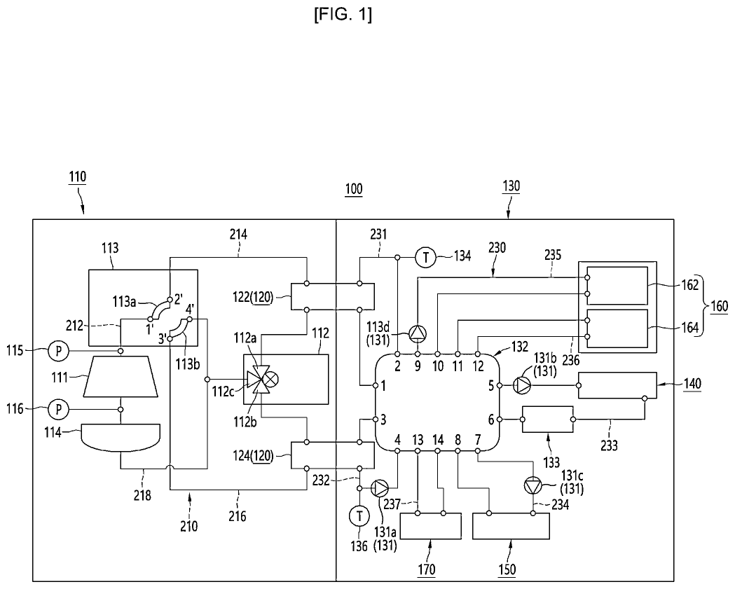

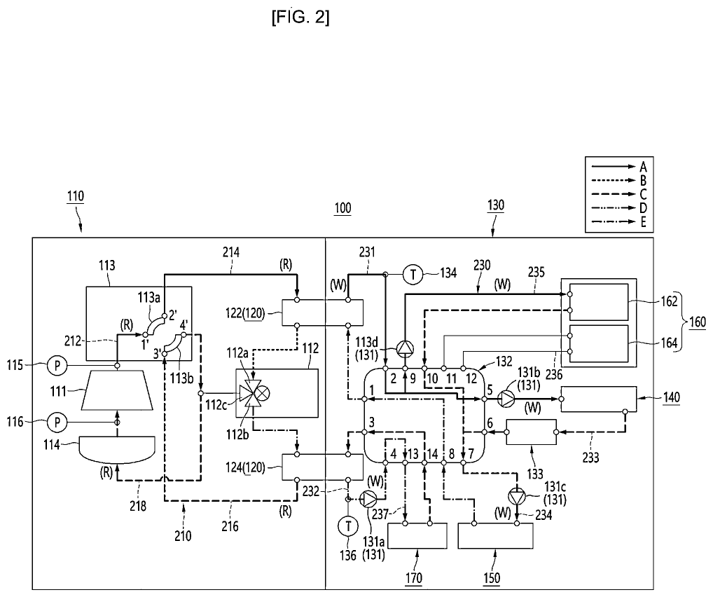

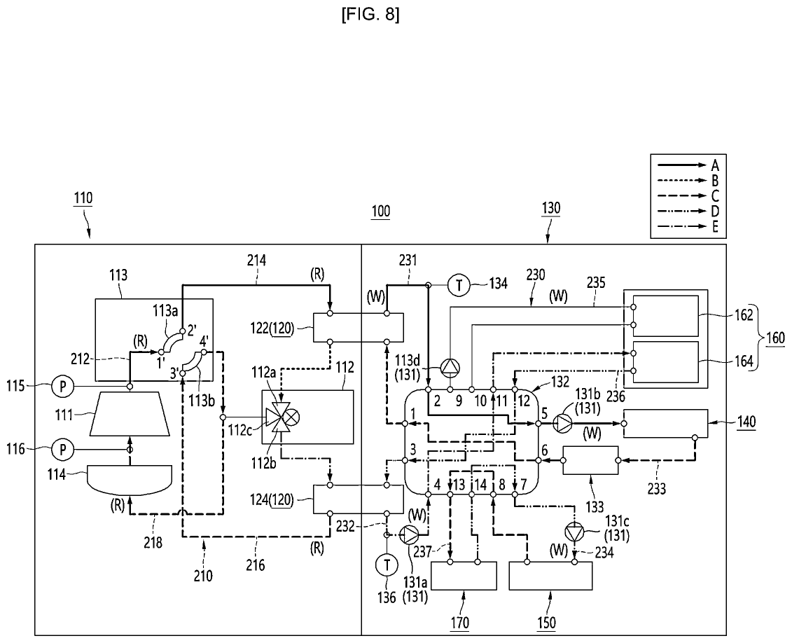

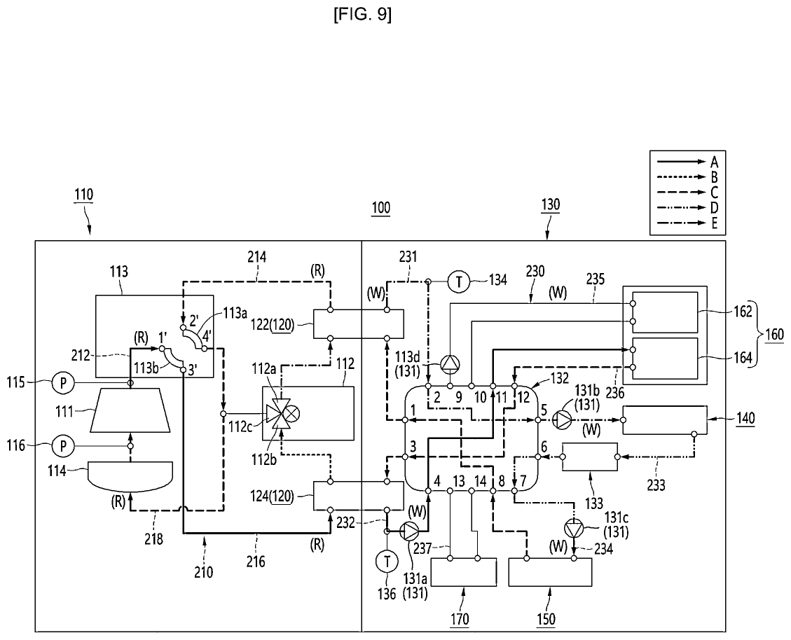

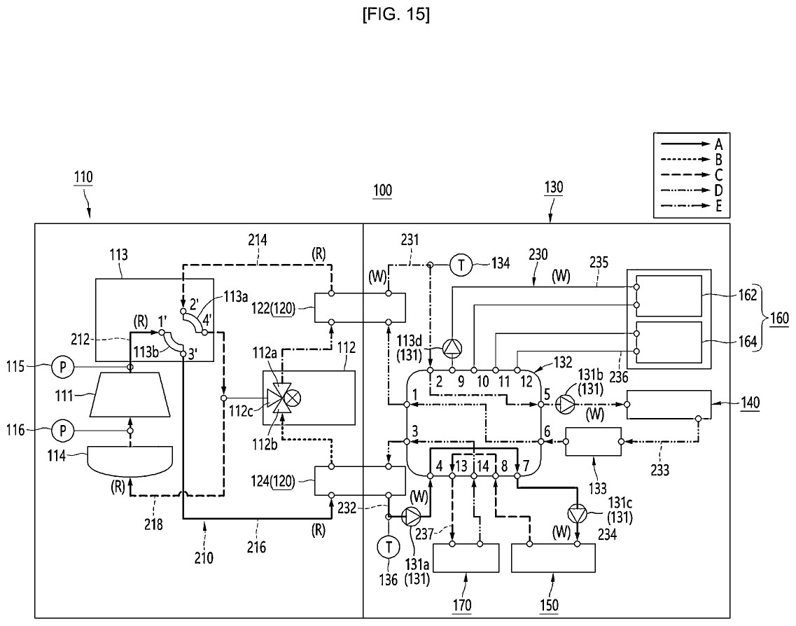

FIG. 1 is a configuration diagram illustrating a thermal management system (100) for an electric vehicle according to an embodiment of the present invention. FIGS. 2 to 7 are diagrams respectively illustrating an ambient heat absorption heating mode, an inefficient heating mode, an inefficient heating drying mode, an ambient heat absorption battery warm-up mode, an inefficient battery warm-up mode, and an inefficient battery warm-up drying mode of the first thermal management mode of the thermal management system (100) shown in FIG. 1. FIG. 8 is a diagram illustrating a battery heat storage mode of the second thermal management mode of the thermal management system (100) shown in FIG. 1. FIGS. 9 to 14 are diagrams respectively illustrating a waste heat recovery heating mode, a defogging mode, a defrosting mode, a battery warm-up followed by dehumidification mode, a battery warm-up followed by battery cooling air-conditioning mode, and an electrical component warm-up cooling mode of the third thermal management mode of the thermal management system (100) shown in FIG. 1. FIGS. 15 to 17 are diagrams respectively illustrating a charging cooling mode, a pre-battery warm-up dehumidification mode, and a pre-battery warm-up battery cooling air-conditioning mode of the fourth thermal management mode of the thermal management system (100) shown in FIG. 1.

Referring to FIG. 1, a thermal management system (100) for an electric vehicle according to an embodiment of the present invention may include a heat pump unit (110), a refrigerant-to-cooling water heat exchanger (120), and a thermal management unit (130).

The thermal management system (100) of the present embodiment may be manufactured as an integrated system that integrates the heat pump unit (110) and the thermal management unit (130) via the refrigerant-to-cooling water heat exchanger (120). This structure enables integrated control of the operation of the heat pump unit (110) and the thermal management unit (130).

Additionally, in the present embodiment, the heat pump unit (110) circulates refrigerant (R) along a refrigerant circulation passage (210), which may be formed of refrigerant piping. Meanwhile, the thermal management unit (130) circulates cooling water (W) along a cooling water circulation passage (230), which may be formed of flexible cooling water hoses. In particular, since the cooling water circulation passage (230) in the present embodiment is formed using cooling water hoses, it may be manufactured at a lower cost, and the flexibility of the hoses allows for easy bending, thereby improving design flexibility and installation convenience of the thermal management unit (130).

Furthermore, while the thermal management system (100) in the present embodiment is described as being applied to an electric vehicle, it is not limited thereto and may also be applied to various mobility platforms, such as vehicles equipped with a battery pack (140), an electrical component module (150), and a cooling water-to-air heat exchanger (160) for an air-conditioning system (e.g., drone air vehicles or electric ships), as well as machinery (e.g., construction equipment such as excavators or agricultural machinery such as combines).

Meanwhile, the battery pack (140) of the present embodiment may include a liquid-cooled heat sink to facilitate cooling via cooling water. The electrical component module (150) of the present embodiment may include a motor that provides driving power for the electric vehicle and a control unit that manages the operation of the electric vehicle. The electrical component module (150) may further include a liquid-cooled condenser through which cooling water flows. The cooling water-to-air heat exchanger (160) of the air-conditioning system in the present embodiment may be positioned inside the cabin of the electric vehicle at two closely adjacent locations to perform various functions, including heating and cooling of indoor air, dehumidification, defogging, and defrosting for the electric vehicle.

Referring to FIGS. 1 to 17, the heat pump unit (110) of the present embodiment may be a device that releases and absorbs heat based on the heat dissipation and condensation heat of a refrigerant and may include a refrigerant circulation passage (210) through which refrigerant (R) circulates. That is, the heat pump unit (110) may perform the function of a combined heating and cooling device that transfers a low-thermal heat source to a high thermal and, at the same time, transfers a high-thermal heat source to a low thermal using the heat dissipation or condensation heat of the refrigerant.

For example, the heat pump unit (110) may include a compressor (111), an expansion valve (112), a refrigerant switching valve (113), an accumulator (114), a first pressure sensor (115), a second pressure sensor (116), and a refrigerant circulation passage (210).

The compressor (111) may compress the refrigerant to a high thermal. The expansion valve (112) may expand the refrigerant to a low thermal. The refrigerant switching valve (113) may be disposed in the refrigerant circulation passage (210) between the compressor (111) and the expansion valve (112) to switch the flow direction of the refrigerant flowing through the refrigerant circulation passage (210). The accumulator (114) may maintain a constant pressure for the refrigerant entering the inlet of the compressor (111). The first pressure sensor (115) may measure the pressure of the refrigerant (R) discharged from the outlet of the compressor (111). The second pressure sensor (116) may measure the pressure of the refrigerant (R) introduced into the inlet of the compressor (111).

As shown in FIG. 1, the refrigerant circulation passage (210) may include: a first refrigerant passage (212) connecting the outlet of the compressor (111) to the first refrigerant port (1′) of the refrigerant switching valve (113), a second refrigerant passage (214) connecting the second refrigerant port (2′) of the refrigerant switching valve (113) to the first inlet/outlet (112a) of the expansion valve (112), a third refrigerant passage (216) connecting the second inlet/outlet (112b) of the expansion valve (112) to the third refrigerant port (3′) of the refrigerant switching valve (113), and a fourth refrigerant passage (218) connecting the fourth refrigerant port (4′) of the refrigerant switching valve (113) to the inlet of the compressor (111).

Here, the expansion valve (112) may be provided as a three-way expansion valve having three inlets/outlets (112a, 112b, 112c) through which the refrigerant flows in and out. That is, the expansion valve (112) may include: a first inlet/outlet (112a) connected to the second refrigerant passage (214), a second inlet/outlet (112b) connected to the third refrigerant passage (216), and a third inlet/outlet (112c) connected to the fourth refrigerant passage (218).

The first inlet/outlet (112a) may be continuously open and connected to the second refrigerant passage (214), and the second inlet/outlet (112b) may be continuously open and connected to the third refrigerant passage (216). Meanwhile, the third inlet/outlet (112c) may be selectively opened or closed and connected to the fourth refrigerant passage (218). When the third inlet/outlet (112c) is selectively opened and closed as described above, a portion of the refrigerant introduced into the expansion valve (112) via the first inlet/outlet (112a) or the second inlet/outlet (112b) may be selectively bypassed to the fourth refrigerant passage (218).

And the refrigerant switching valve (113) may be provided as a four-way switching valve having a first refrigerant port (1′), a second refrigerant port (2′), a third refrigerant port (3′), and a fourth refrigerant port (4′). The first refrigerant port (1′) may be communicably connected to one end of the first refrigerant passage (212), the second refrigerant port (2′) may be communicably connected to one end of the second refrigerant passage (214), the third refrigerant port (3′) may be communicably connected to one end of the third refrigerant passage (216), and the fourth refrigerant port (4′) may be communicably connected to one end of the fourth refrigerant passage (218).

In the present embodiment, the heat pump unit (110) may change the shape of the refrigerant circulation passage (210) based on the operation of the refrigerant switching valve (113), thereby modifying the flow pattern of the refrigerant (R). Based on this modification, the heat pump unit (110) may operate in either a first refrigerant flow mode or a second refrigerant flow mode.

To achieve this, the refrigerant switching valve (113) may further include: a first internal passage (113a) configured to selectively connect the first refrigerant port (1′) to either the second refrigerant port (2′) or the third refrigerant port (3′), and a second internal passage (113b) configured to selectively connect the fourth refrigerant port (4′) to either the second refrigerant port (2′) or the third refrigerant port (3′).

In the first refrigerant flow mode, the first internal passage (113a) may connect the first refrigerant port (1′) to the second refrigerant port (2′), and the second internal passage (113b) may connect the fourth refrigerant port (4′) to the third refrigerant port (3′). That is, in the first refrigerant flow mode, the refrigerant switching valve (113) may be positioned at a first position, where the first refrigerant port (1′) and the second refrigerant port (2′) are connected through the first internal passage (113a), allowing the first refrigerant passage (212) and the second refrigerant passage (214) to be communicably connected. Similarly, the third refrigerant port (3′) and the fourth refrigerant port (4′) may be connected through the second internal passage (113b), allowing the third refrigerant passage (216) and the fourth refrigerant passage (218) to be communicably connected.

In the second refrigerant flow mode, the first internal passage (113a) may connect the first refrigerant port (1′) to the third refrigerant port (3′), and the second internal passage (113b) may connect the fourth refrigerant port (4′) to the second refrigerant port (2′). That is, in the second refrigerant flow mode, the refrigerant switching valve (113) may be positioned at a second position, which is rotated 45 degrees from the first position. At this second position, the first refrigerant port (1′) and the third refrigerant port (3′) may be connected through the first internal passage (113a), allowing the first refrigerant passage (212) and the third refrigerant passage (216) to be communicably connected. Similarly, the fourth refrigerant port (4′) and the second refrigerant port (2′) may be connected through the second internal passage (113b), allowing the fourth refrigerant passage (218) and the second refrigerant passage (214) to be communicably connected.

Referring to FIGS. 1 to 17, the refrigerant-to-cooling water heat exchanger (120) of the present embodiment may be connected to the refrigerant circulation passage (210) of the heat pump unit (110) and the cooling water circulation passage (230) of the thermal management unit (130), which will be described later, to exchange heat between the refrigerant (R) of the heat pump unit (110) and the cooling water (W) of the thermal management unit (130). As an example, the refrigerant-to-cooling water heat exchanger (120) may be provided as a plate-type heat exchanger made of a heat-conductive material. In this case, one side of the refrigerant-to-cooling water heat exchanger (120) may be connected to the refrigerant circulation passage (210), and the other side of the refrigerant-to-cooling water heat exchanger (120) may be connected to the cooling water circulation passage (230).

For example, the refrigerant-to-cooling water heat exchanger (120) may include a first refrigerant-to-cooling water heat exchanger (122) and a second refrigerant-to-cooling water heat exchanger (124).

The first refrigerant-to-cooling water heat exchanger (122) may be disposed to allow heat exchange between the second refrigerant passage (214) of the refrigerant circulation passage (210) and the first cooling water passage (231) of the cooling water circulation passage (230), which will be described later. One side of the first refrigerant-to-cooling water heat exchanger (122) may be thermally connected to the second refrigerant passage (214) of the refrigerant circulation passage (210). The other side of the first refrigerant-to-cooling water heat exchanger (122) may be thermally connected to the first cooling water passage (231) of the cooling water circulation passage (230), which will be described later.

The second refrigerant-to-cooling water heat exchanger (124) may be disposed to allow heat exchange between the third refrigerant passage (216) of the refrigerant circulation passage (210) and the second cooling water passage (232) of the cooling water circulation passage (230), which will be described later. One side of the second refrigerant-to-cooling water heat exchanger (124) may be thermally connected to the third refrigerant passage (216) of the refrigerant circulation passage (210). The other side of the second refrigerant-to-cooling water heat exchanger (124) may be thermally connected to the second cooling water passage (232) of the cooling water circulation passage (230), which will be described later. When the refrigerant switching valve (113) operates in the first position of the first refrigerant flow mode. The first refrigerant-to-cooling water heat exchanger (122) may use the high-thermal refrigerant (R) flowing through the second refrigerant passage (214) to heat the cooling water (W) flowing through the first cooling water passage (231).

The second refrigerant-to-cooling water heat exchanger (124) may use the low-thermal refrigerant (R) flowing through the third refrigerant passage (216) to cool the cooling water (W) flowing through the second cooling water passage (232). Additionally, when the refrigerant switching valve (113) operates in the second position of the second refrigerant flow mode. The first refrigerant-to-cooling water heat exchanger (122) may use the low-thermal refrigerant (R) flowing through the second refrigerant passage (214) to cool the cooling water (W) flowing through the first cooling water passage (231).

The second refrigerant-to-cooling water heat exchanger (124) may use the high-thermal refrigerant (R) flowing through the second refrigerant passage (214) to heat the cooling water (W) flowing through the second cooling water passage (232).

Referring to FIGS. 1 to 17, the thermal management unit (130) of the present embodiment may appropriately regulate the thermal of the cooling water (W) using the refrigerant-to-cooling water heat exchanger (120), a radiator (170), and a cooling water heater (133), which will be described later. The cooling water (W) may then be used to regulate the thermal of the battery pack (140), the electrical component module (150), and the cooling water-to-air heat exchanger (160) according to the driving conditions of the electric vehicle and the surrounding environment.

The cooling water (W) of the thermal management unit (130) may be heated or cooled through the first refrigerant-to-cooling water heat exchanger (122) and the second refrigerant-to-cooling water heat exchanger (124), which exchange heat with the refrigerant (R) of the heat pump unit (110).

To achieve this, the thermal management unit (130) may include a cooling water circulation passage (230), which circulates cooling water (W) to the battery pack (140), the electrical component module (150), and the cooling water-to-air heat exchanger (160).

Accordingly, the thermal management unit (130) may modify the flow pattern of the cooling water circulation passage (230), allowing the cooling water (W) to regulate the thermals of the battery pack (140), the electrical component module (150), and the cooling water-to-air heat exchanger (160) in various ways.

For example, the thermal management unit (130) of the present embodiment may include: a cooling water pump (131), a cooling water control valve (132), a cooling water heater (133), a first thermal sensor (134), a second thermal sensor (136), and the cooling water circulation passage (230).

As shown in FIG. 1, the cooling water pump (131) may pump the cooling water (W) flowing through the cooling water circulation passage (230) in the desired direction and at a desired flow rate.

For example, the cooling water pump (131) may be provided as: a first cooling water pump (131a), a second cooling water pump (131b), a third cooling water pump (131c), and a fourth cooling water pump (131d).

The first cooling water pump (131a) may be disposed in the second cooling water passage (232) of the cooling water circulation passage (230), which will be described later, to pump cooling water from the second refrigerant-to-cooling water heat exchanger (124) to the cooling water control valve (132). The second cooling water pump (131b) may be disposed in the third cooling water passage (233) of the cooling water circulation passage (230), which will be described later, to pump cooling water from the cooling water control valve (132) to the battery pack (140). The third cooling water pump (131c) may be disposed in the fourth cooling water passage (234) of the cooling water circulation passage (230), which will be described later, to pump cooling water from the cooling water control valve (132) to the electrical component module (150). The fourth cooling water pump (131d) may be disposed in the fifth cooling water passage (235) of the cooling water circulation passage (230), which will be described later, to pump cooling water from the cooling water control valve (132) to the first cooling water-to-air heat exchanger (162).

As shown in FIG. 1, the cooling water control valve (132) may be disposed in the cooling water circulation passage (230) to modify the flow pattern of the cooling water circulation passage (230) and set the thermal management mode of the thermal management unit (130). By modifying the thermal management mode of the thermal management unit (130), the cooling water control valve (132) may regulate the thermal of the battery pack (140), the electrical component module (150), and the cooling water-to-air heat exchanger (160) in various ways. In this embodiment, the cooling water control valve (132) is described as a 14-way control valve with 14 cooling water ports (1 to 14). However, the present invention is not limited to this configuration, and the cooling water control valve (132) may be modified in various ways depending on the number of flow patterns regulated by the cooling water circulation passage (230). The thermal management modes of the thermal management unit (130), which are selected based on the operating patterns of the cooling water control valve (132), may be predefined to allow various thermal settings for the battery pack (140), the electrical component module (150), and the cooling water-to-air heat exchanger (160) according to the driving conditions of the electric vehicle and the surrounding environment. A detailed explanation of these thermal management modes and the corresponding operating patterns of the cooling water control valve (132) will be described later.

As shown in FIG. 1, the cooling water heater (133) is a cooling water heating device provided in the cooling water circulation passage (230) to raise the thermal of the cooling water that has passed through the battery pack (140) to a preset thermal in advance. Specifically, the cooling water heater (133) may be disposed in the third cooling water passage (233) of the cooling water circulation passage (230), which will be described later, to heat the cooling water flowing from the battery pack (140) to the sixth cooling water port (6) of the cooling water control valve (132). The cooling water heater (133) may be positioned between the battery pack (140) and the sixth cooling water port (6).

As shown in FIG. 1, the first thermal sensor (134) may be disposed in the first cooling water passage (231) of the cooling water circulation passage (230), which will be described later, and may be located between the first refrigerant-to-cooling water heat exchanger (122) and the second cooling water port (2) of the cooling water control valve (132) to measure in real time the thermal of the cooling water flowing from the first refrigerant-to-cooling water heat exchanger (122) to the cooling water control valve (132). Specifically, the first thermal sensor (134) may measure in real time the thermal of the cooling water (W) flowing to the second cooling water port (2) of the cooling water control valve (132) after heat exchange with the refrigerant (R) in the first refrigerant-to-cooling water heat exchanger (122).

As shown in FIG. 1, the second thermal sensor (136) may be disposed in the second cooling water passage (232) of the cooling water circulation passage (230), which will be described later, and may be located between the second refrigerant-to-cooling water heat exchanger (124) and the fourth cooling water port (4) of the cooling water control valve (132) to measure in real time the thermal of the cooling water flowing from the second refrigerant-to-cooling water heat exchanger (124) to the cooling water control valve (132). Specifically, the second thermal sensor (136) may measure in real time the thermal of the cooling water (W) flowing to the fourth cooling water port (4) of the cooling water control valve (132) after heat exchange with the refrigerant (R) in the second refrigerant-to-cooling water heat exchanger (124).

As shown in FIG. 1, the cooling water circulation passage (230) may include a first cooling water passage (231), a second cooling water passage (232), a third cooling water passage (233), a fourth cooling water passage (234), a fifth cooling water passage (235), a sixth cooling water passage (236), and a seventh cooling water passage (237).

The first cooling water passage (231) may be formed to connect the first cooling water port (1) and the second cooling water port (2) of the cooling water control valve (132) and may be connected to the opposite side of the first refrigerant-to-cooling water heat exchanger (122) and the first thermal sensor (134).

The second cooling water passage (232) may be formed to connect the third cooling water port (3) and the fourth cooling water port (4) of the cooling water control valve (132), and may be connected to the opposite side of the second refrigerant-to-cooling water heat exchanger (124), the second thermal sensor (136), and the first cooling water pump (131a).

The third cooling water passage (233) may be formed to connect the fifth cooling water port (5) and the sixth cooling water port (6) of the cooling water control valve (132), and may be connected to the first cooling water pump (131b), the battery pack (140), and the cooling water heater (133).

The fourth cooling water passage (234) may be formed to connect the seventh cooling water port (7) and the eighth cooling water port (8) of the cooling water control valve (132), and may be connected to the third cooling water pump (131c) and the electrical component module (150).

The fifth cooling water passage (235) may be formed to connect the ninth cooling water port (9) and the tenth cooling water port (10) of the cooling water control valve (132), and may be connected to the fourth cooling water pump (131d) and the first cooling water-to-air heat exchanger (162).

The sixth cooling water passage (236) may be formed to connect the eleventh cooling water port (11) and the twelfth cooling water port (12) of the cooling water control valve (132), and may be connected to the second cooling water-to-air heat exchanger (164).

The seventh cooling water passage (237) may be formed to connect the thirteenth cooling water port (13) and the fourteenth cooling water port (14) of the cooling water control valve (132), and may be connected to the radiator (170).

Referring to FIGS. 1 to 17, the thermal management system (100) of the present embodiment may further include a radiator (170) for heat exchange between the cooling water (W) and the outside air. That is, the radiator (170) may dissipate the heat of the cooling water flowing through the cooling water circulation passage (230) to the outside air through heat exchange or absorb the heat of the outside air into the cooling water. The radiator (170) may be disposed in the seventh cooling water passage (237) of the cooling water circulation passage (230).

The radiator (170), as described above, may be manufactured as a separate component different from conventional radiators used in electric vehicles and installed in the thermal management unit (130). However, it is also possible for the radiator (170) to be shared with the existing radiator used in electric vehicles instead of being manufactured as a separate component exclusively for the thermal management unit (130). Therefore, if the existing radiator (170) used in electric vehicles is also used in the thermal management unit (120), it may achieve component standardization of the radiator (170), providing cost reduction and installation space efficiency.

A detailed description of the thermal management modes of the thermal management unit (130) in the thermal management system (100) of the present embodiment configured as described above is provided below.

For reference, in FIGS. 2 to 17, various types of arrows (A, B, C, D, E) are used to clearly indicate the flow direction and thermal of the refrigerant (R) and cooling water (W) flowing in the heat pump unit (110) and the thermal management unit (130). At this time, the arrows (A, B, C, D, E) displayed in the heat pump unit (110) represent the refrigerant (R) flowing through the refrigerant circulation passage (210), while the arrows (A, B, C, D, E) displayed in the thermal management unit (130) represent the cooling water (W) flowing through the cooling water circulation passage (230).

For example, a solid arrow (A) represents the high-thermal state of the refrigerant (R) or cooling water (W), a short-dashed arrow (B) represents the medium-high-thermal state of the refrigerant (R) or cooling water (W), a long-dashed arrow (C) represents the medium-thermal state of the refrigerant (R) or cooling water (W), a double-dotted dashed arrow (D) represents the medium-low-thermal state of the refrigerant (R) or cooling water (W), and a single-dotted dashed arrow (E) represents the low-thermal state of the refrigerant (R) or cooling water (W).

Referring to FIGS. 2 to 17, the thermal management modes of the thermal management unit (130) according to the present embodiment may be classified into a first thermal management mode, a second thermal management mode, a third thermal management mode, and a fourth thermal management mode based on the heat exchange pattern between the refrigerant (R) and the cooling water (W) in the first refrigerant-to-cooling water heat exchanger (122). That is, the first to fourth thermal management modes are distinguished based on the heat exchange pattern of the first refrigerant-to-cooling water heat exchanger (122), which will be explained in more detail below.

FIGS. 2 to 7 each illustrate various embodiments of the first thermal management mode. In the first thermal management mode, the heat pump unit (110) may operate in the first refrigerant flow mode, and the thermal management unit (130) may operate to heat the low-thermal cooling water (W) flowing along the first cooling water passage (231) in the first refrigerant-to-cooling water heat exchanger (122) and then deliver it to the battery pack (140) and the electrical component module (150). In other words, the first thermal management mode allows the first refrigerant-to-cooling water heat exchanger (122) to heat the cooling water (W) of the thermal management unit (130) using the refrigerant (R) of the heat pump unit (110) and thereby increase the thermal of the battery pack (140).

FIG. 8 illustrates an embodiment of the second thermal management mode. In the second thermal management mode, the heat pump unit (110) may operate in the first refrigerant flow mode, and the thermal management unit (130) may heat the medium-thermal cooling water (W) flowing along the first cooling water passage (231) in the first refrigerant-to-cooling water heat exchanger (122) and then deliver it to the battery pack (140). That is, similar to the first thermal management mode, the second thermal management mode allows the first refrigerant-to-cooling water heat exchanger (122) to heat the cooling water (W) of the thermal management unit (130) using the refrigerant (R) of the heat pump unit (110) and thereby increase the thermal of the battery pack (140).

FIGS. 9 to 14 illustrate various embodiments of the third thermal management mode. In the third thermal management mode, the heat pump unit (110) may operate in the second refrigerant flow mode, and the thermal management unit (130) may cool the medium-thermal cooling water (W) flowing along the first cooling water passage (231) in the first refrigerant-to-cooling water heat exchanger (122) and then deliver it to the battery pack (140) or the power electronics module (150). That is, unlike the first and second thermal management modes, the third thermal management mode allows the first refrigerant-to-cooling water heat exchanger (122) to cool the cooling water (W) of the thermal management unit (130) using the refrigerant (R) of the heat pump unit (110) and thereby lower the thermal of the battery pack (140).

FIGS. 15 to 17 illustrate embodiments of the fourth thermal management mode. In the fourth thermal management mode, the heat pump unit (110) may operate in the second refrigerant flow mode, and the thermal management unit (130) may cool the medium-low-thermal cooling water (W) flowing along the first cooling water passage (231) in the first refrigerant-to-cooling water heat exchanger (122) and then deliver it to the battery pack (140). That is, similar to the third thermal management mode, the fourth thermal management mode allows the first refrigerant-to-cooling water heat exchanger (122) to cool the cooling water (W) of the thermal management unit (130) using the refrigerant (R) of the heat pump unit (110) and thereby lower the thermal of the battery pack (140).

As described above, the thermal management modes of the thermal management unit (130) are classified into four modes based on the heat exchange pattern between the cooling water (W) and the refrigerant (R) in the first refrigerant-to-cooling water heat exchanger (122), and these first to fourth thermal management modes are disclosed in FIGS. 2 to 17. Below, embodiments of the first to fourth thermal management modes will be described in detail with reference to FIGS. 2 to 17.

FIGS. 2 to 7 illustrate various embodiments of the first thermal management mode, which may include an ambient heat absorption heating mode, an inefficient heating mode, an inefficient heating drying mode, an ambient heat absorption battery warm-up mode, an inefficient battery warm-up mode, and an inefficient battery warm-up drying mode.

FIG. 2 is a diagram illustrating the ambient heat absorption heating mode of the first thermal management mode in the thermal management system (100) shown in FIG. 1.

As shown in FIG. 2, the ambient heat absorption heating mode is performed under environmental conditions where the ambient thermal is higher than the evaporation thermal of the refrigerant, and it may increase the thermals of the battery pack (140), the first cooling water-to-air heat exchanger (162), and the electric component module (150) using the high-thermal cooling water heated by the first refrigerant-to-cooling water heat exchanger (122). Furthermore, it may absorb the ambient thermal into the second refrigerant-to-cooling water heat exchanger (124) through the radiator (170).

Here, the cooling water control valve (132) opens the first and second cooling water ports (1, 2) to allow the cooling water (W) to flow in the first cooling water passage (231). It also opens the fifth and sixth cooling water ports (5, 6) to receive the cooling water (W) flowing into the second cooling water port (2) and deliver it to the third cooling water passage (233) via the fifth cooling water port (5). Additionally, it opens the ninth and tenth cooling water ports (9, 10) to receive the cooling water (W) flowing into the second cooling water port (2) and deliver it to the fifth cooling water passage (235) via the ninth cooling water port (9). Moreover, it opens the seventh and eighth cooling water ports (7, 8) to receive the cooling water (W) flowing into the sixth and tenth cooling water ports (6, 10) and deliver it to the fourth cooling water passage (234) via the seventh cooling water port (7). Subsequently, the cooling water (W) flowing into the eighth cooling water port (8) is delivered to the first cooling water port (1).

Furthermore, the cooling water control valve (132) opens the third and fourth cooling water ports (3, 4) to allow the cooling water (W) to flow in the second cooling water passage (232). It also opens the thirteenth and fourteenth cooling water ports (13, 14) to receive the cooling water (W) flowing into the fourth cooling water port (4) and deliver it to the seventh cooling water passage (237) via the thirteenth cooling water port (13). Subsequently, the cooling water (W) flowing into the fourteenth cooling water port (14) is delivered to the third cooling water port (3).

As a result, the cooling water control valve (132) delivers the high-thermal cooling water (W) heated in the first refrigerant-to-cooling water heat exchanger (122) from the first cooling water passage (231) to the battery pack (140) and the first cooling water-to-air heat exchanger (162) via the third cooling water passage (233) and the fifth cooling water passage (235), thereby increasing their thermals. Additionally, the cooling water control valve (132) delivers the medium-thermal cooling water (W), which has been cooled by the battery pack (140) and the first cooling water-to-air heat exchanger (162), from the third cooling water passage (233) and the fifth cooling water passage (235) to the electric component module (150) via the fourth cooling water passage (234), thereby increasing the thermal of the electric component module (150). Moreover, the cooling water control valve (132) delivers the cooling water (W), which has undergone heat exchange with the ambient thermal in the radiator (170) and has reached a medium thermal, from the seventh cooling water passage (237) to the second refrigerant-to-cooling water heat exchanger (124) via the second cooling water passage (232), thereby increasing the thermal of the second refrigerant-to-cooling water heat exchanger (124).

On the other hand, the ambient heat absorption heating mode is a mode that utilizes indirect evaporation through the radiator (170) in winter when the evaporation thermal of the refrigerant is lower than the ambient thermal. In the ambient heat absorption heating mode, the cooling water passage (230) formed between the radiator (170) and the second refrigerant-to-cooling water heat exchanger (124) and the cooling water circulation passage (230) formed between the battery pack (140), the electric component module (150), the first cooling water-to-air heat exchanger (162), and the first refrigerant-to-cooling water heat exchanger (122) are separated so that the cooling water may flow independently.

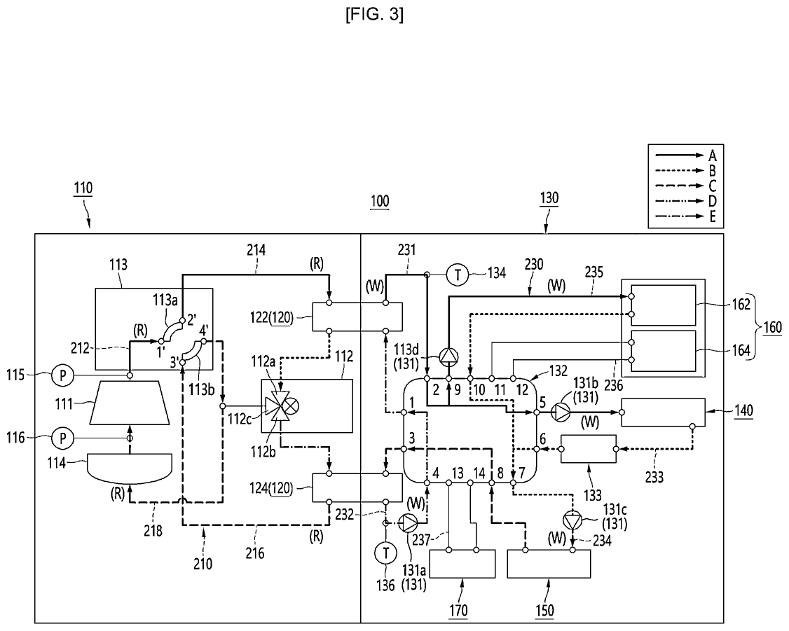

FIG. 3 is a diagram illustrating the inefficient heating mode of the first thermal management mode in the thermal management system (100) shown in FIG. 1.

As shown in FIG. 3, the inefficient heating mode is performed under extreme cold environmental conditions where ambient heat absorption is not possible. In this mode, the high-thermal cooling water heated by the first refrigerant-to-cooling water heat exchanger (122) may be used to increase the thermals of the battery pack (140), the first cooling water-to-air heat exchanger (162), and the electric component module (150). Additionally, the cooling water (W), which has increased the thermals of the battery pack (140), the first cooling water-to-air heat exchanger (162), and the electric component module (150), may be cooled in the second refrigerant-to-cooling water heat exchanger (124).

Here, the cooling water control valve (132) opens the first and second cooling water ports (1, 2) to allow the cooling water (W) to flow through the first cooling water passage (231). It also opens the fifth and sixth cooling water ports (5, 6) to receive the cooling water (W) flowing into the second cooling water port (2) and deliver it to the third cooling water passage (233) via the fifth cooling water port (5). Additionally, it opens the ninth and tenth cooling water ports (9, 10) to receive the cooling water (W) flowing into the second cooling water port (2) and deliver it to the fifth cooling water passage (235) via the ninth cooling water port (9). Moreover, it opens the seventh and eighth cooling water ports (7, 8) to receive the cooling water (W) flowing into the sixth and tenth cooling water ports (6, 10) and deliver it to the fourth cooling water passage (234) via the seventh cooling water port (7). Furthermore, it opens the third and fourth cooling water ports (3, 4) to receive the cooling water (W) flowing into the eighth cooling water port (8) and deliver it to the second cooling water passage (232) via the third cooling water port (3). Finally, the cooling water (W) flowing into the fourth cooling water port (4) is delivered to the first cooling water port (1).

As a result, the cooling water control valve (132) may deliver the high-thermal cooling water (W), heated by the first refrigerant-to-cooling water heat exchanger (122), from the first cooling water passage (231) through the third cooling water passage (233) and the fifth cooling water passage (235) to the battery pack (140) and the first cooling water-to-air heat exchanger (162), thereby increasing the thermals of the battery pack (140) and the first cooling water-to-air heat exchanger (162). Additionally, the cooling water control valve (132) may deliver the cooling water (W), which has been cooled to a moderately high thermal in the battery pack (140) and the first cooling water-to-air heat exchanger (162), from the third cooling water passage (233) and the fifth cooling water passage (235) through the fourth cooling water passage (234) to the electric component module (150), thereby increasing the thermal of the electric component module (150). Furthermore, the cooling water control valve (132) may deliver the cooling water (W), which has been cooled to a moderate thermal in the electric component module (150), from the fourth cooling water passage (234) through the second cooling water passage (232) to the second refrigerant-to-cooling water heat exchanger (124), thereby increasing the thermal of the second refrigerant-to-cooling water heat exchanger (124).

Meanwhile, the inefficient heating mode is a heating and warming mode that utilizes the residual heat of the cooling water (W) that has heated the battery pack (140), the electric component module (150), and the first cooling water-to-air heat exchanger (162). The inefficient heating mode may be used in extreme cold environments where ambient heat absorption is not possible, and as a result, the compressor (111) of the heat pump unit (110) may function as a heater.

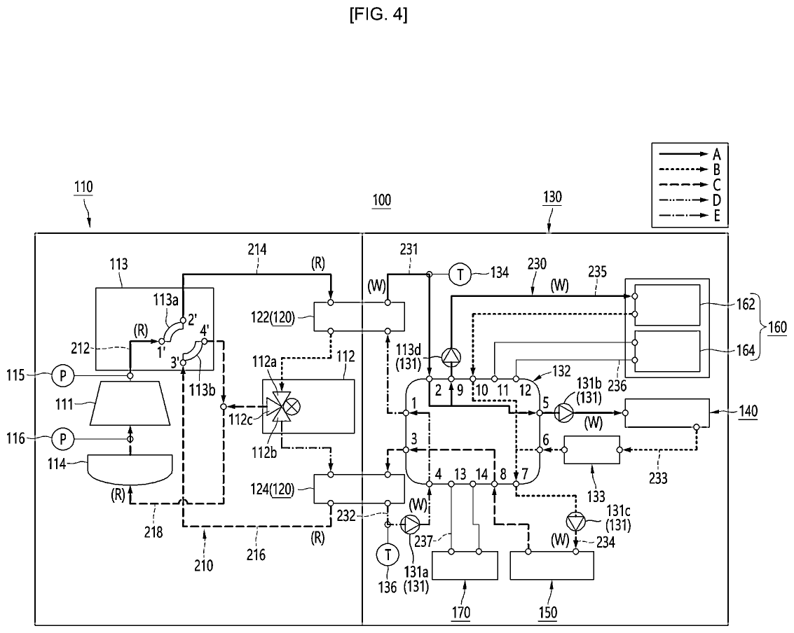

FIG. 4 illustrates the inefficient heating drying mode of the first thermal management mode in the thermal management system (100) shown in FIG. 1.

As shown in FIG. 4, the inefficient heating drying mode is performed under extreme cold environmental conditions where ambient heat absorption is not possible. In this mode, high-thermal cooling water (W) heated by the first refrigerant-to-cooling water heat exchanger (122) may be used to increase the thermals of the battery pack (140), the first cooling water-to-air heat exchanger (162), and the electric component module (150). Additionally, the cooling water (W), which has been used to raise the thermals of the battery pack (140), the first cooling water-to-air heat exchanger (162), and the electric component module (150), may be cooled in the second refrigerant-to-cooling water heat exchanger (124).

Furthermore, the inefficient heating drying mode is similar to the inefficient heating mode shown in FIG. 3. However, in particular, a portion of the refrigerant (R) introduced into the expansion valve (112) may be bypassed to the fourth refrigerant passage (218) via the third inlet/outlet (112c).

As a result, the cooling water control valve (132) delivers the high-thermal cooling water (W), heated by the first refrigerant-to-cooling water heat exchanger (122), from the first cooling water passage (231) through the third cooling water passage (233) and the fifth cooling water passage (235) to the battery pack (140) and the first cooling water-to-air heat exchanger (162), thereby increasing the thermals of the battery pack (140) and the first cooling water-to-air heat exchanger (162). Additionally, the cooling water control valve (132) delivers the cooling water (W), which has been cooled to a moderately high thermal in the battery pack (140) and the first cooling water-to-air heat exchanger (162), from the third cooling water passage (233) and the fifth cooling water passage (235) through the fourth cooling water passage (234) to the electric component module (150), thereby increasing the thermal of the electric component module (150). Furthermore, the cooling water control valve (132) delivers the cooling water (W), which has been cooled to a moderate thermal in the electric component module (150), from the fourth cooling water passage (234) through the second cooling water passage (232) to the second refrigerant-to-cooling water heat exchanger (124), thereby increasing the thermal of the second refrigerant-to-cooling water heat exchanger (124).

Meanwhile, the inefficient heating drying mode is a heating and warming mode that utilizes the residual heat of the cooling water (W) that has heated the battery pack (140), the electric component module (150), and the first cooling water-to-air heat exchanger (162). However, unlike the inefficient heating mode, the inefficient heating drying mode bypasses a portion of the refrigerant introduced into the expansion valve (112) to the compressor (111) side, thereby improving the low dryness level of the heat pump unit (110) caused by inefficient heating.

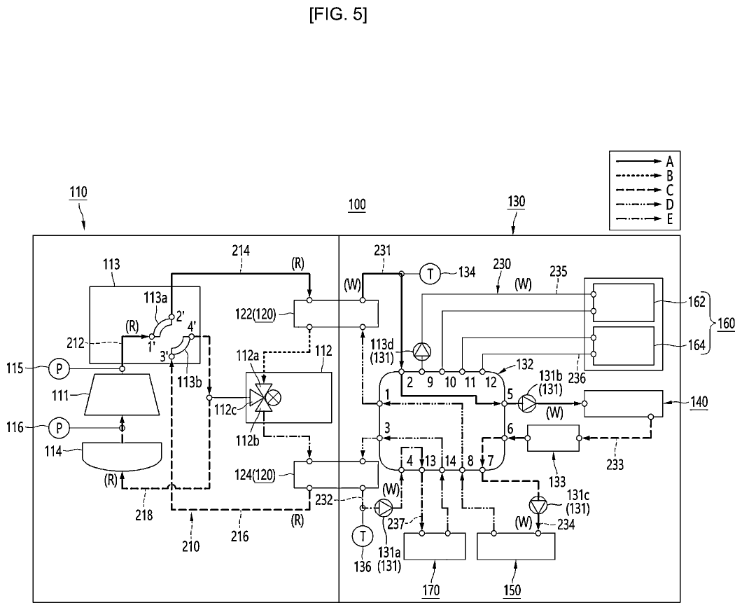

FIG. 5 illustrates the ambient heat absorption battery warm-up mode of the first thermal management mode in the thermal management system (100) shown in FIG. 1.

As shown in FIG. 5, the ambient heat absorption battery warm-up mode is performed under environmental conditions where the operation of the air conditioning system is unnecessary. In this mode, high-thermal cooling water (W) heated by the first refrigerant-to-cooling water heat exchanger (122) may be used to increase the thermals of the battery pack (140) and the electric component module (150), while low-thermal cooling water (W) cooled by the second refrigerant-to-cooling water heat exchanger (124) may absorb heat from external air through the radiator (170).

Here, the cooling water control valve (132) opens the first and second cooling water ports (1, 2) to flow cooling water (W) into the first cooling water passage (231), opens the fifth and sixth cooling water ports (5, 6) to receive the cooling water (W) introduced into the second cooling water port (2) and deliver it to the fifth cooling water port (5), thereby directing it into the third cooling water passage (233). It also opens the seventh and eighth cooling water ports (7, 8) to receive the cooling water (W) introduced into the sixth cooling water port (6) and deliver it to the seventh cooling water port (7), thereby directing it into the fourth cooling water passage (234), and subsequently, the cooling water (W) introduced into the eighth cooling water port (8) is delivered to the first cooling water port (1).

Additionally, the cooling water control valve (132) opens the third and fourth cooling water ports (3, 4) to flow cooling water (W) into the second cooling water passage (232), and opens the thirteenth and fourteenth cooling water ports (13, 14) to receive the cooling water (W) introduced into the fourth cooling water port (4) and deliver it to the thirteenth cooling water port (13), thereby directing it into the seventh cooling water passage (237). Subsequently, the cooling water (W) introduced into the fourteenth cooling water port (14) is delivered to the third cooling water port (3).

As a result, the cooling water control valve (132) delivers high-thermal cooling water (W) heated by the first refrigerant-to-cooling water heat exchanger (122) from the first cooling water passage (231) through the third cooling water passage (233) to the battery pack (140), thereby increasing the thermal of the battery pack (140). Additionally, the cooling water control valve (132) delivers the cooling water (W), which has been cooled to a moderate thermal in the battery pack (140), from the third cooling water passage (233) through the fourth cooling water passage (234) to the electric component module (150), thereby increasing the thermal of the electric component module (150). Furthermore, the cooling water control valve (132) delivers the cooling water (W), which has been heat-exchanged to a moderately low thermal by the external air in the radiator (170), from the seventh cooling water passage (237) through the second cooling water passage (232) to the second refrigerant-to-cooling water heat exchanger (124), thereby increasing the thermal of the second refrigerant-to-cooling water heat exchanger (124).

Meanwhile, the external heat absorption battery warm-up mode is a mode in which the battery pack (140) is warmed up while the operation of the air conditioning unit is stopped. In the external heat absorption battery warm-up mode, when the occupant does not request heating or when the interior heating is sufficient, the interior heating and cooling by the first and second cooling water-to-air heat exchangers (162, 164) of the air conditioning unit may be stopped, and in that state, the battery pack (140) may be warmed up by utilizing heat absorption through the radiator (170).

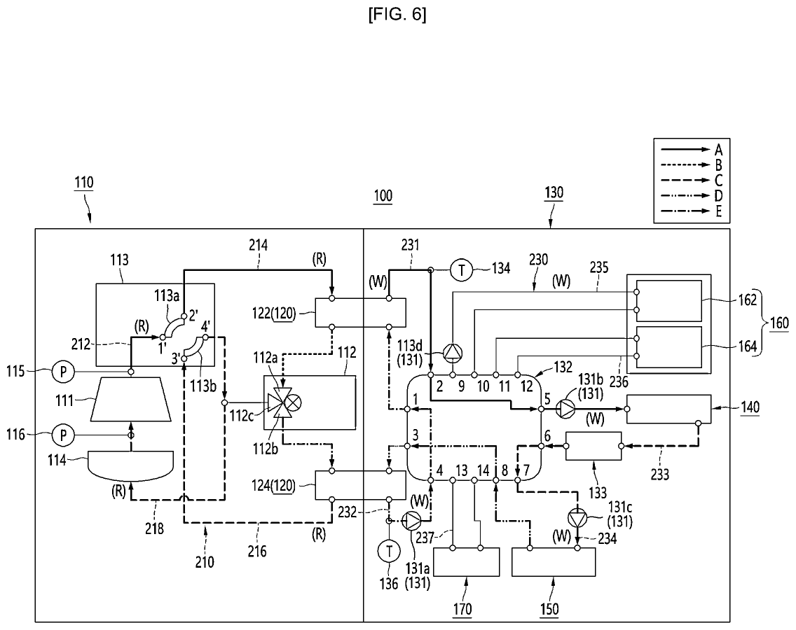

FIG. 6 illustrates an inefficient battery warm-up mode of the first thermal management mode of the thermal management system (100) shown in FIG. 1.

As illustrated in FIG. 6, the inefficient battery warm-up mode is performed under environmental conditions where the operation of the air conditioning unit is unnecessary. In this mode, the thermal of the battery pack (140) and the electrical component module (150) may be increased by using the high-thermal cooling water (W) heated by the first refrigerant-to-cooling water heat exchanger (122), and the cooling water (W) that has increased the thermal of the battery pack (140) and the electrical component module (150) may be cooled by the second refrigerant-to-cooling water heat exchanger (124).

Here, the cooling water control valve (132) opens the first and second cooling water ports (1, 2) to allow the cooling water (W) to flow in the first cooling water passage (231), opens the fifth and sixth cooling water ports (5, 6) to receive the cooling water (W) flowing into the second cooling water port (2) at the fifth cooling water port (5) and flow it into the third cooling water passage (233), opens the seventh and eighth cooling water ports (7, 8) to receive the cooling water (W) flowing into the sixth cooling water port (6) at the seventh cooling water port (7) and flow it into the fourth cooling water passage (234), and opens the third and fourth cooling water ports (3, 4) to receive the cooling water (W) flowing into the eighth cooling water port (8) at the third cooling water port (3) and flow it into the second cooling water passage (232), before delivering the cooling water (W) flowing into the fourth cooling water port (4) to the first cooling water port (1).

As a result, the cooling water control valve (132) may deliver the high-thermal cooling water (W) heated by the first refrigerant-to-cooling water heat exchanger (122) from the first cooling water passage (231) through the third cooling water passage (233) to the battery pack (140), increasing the thermal of the battery pack (140). Alternatively, the cooling water control valve (132) may deliver the medium-thermal cooling water (W) cooled in the battery pack (140) from the third cooling water passage (233) through the fourth cooling water passage (234) to the electrical component module (150), increasing the thermal of the electrical component module (150). Additionally, the cooling water control valve (132) may deliver the medium-low-thermal cooling water (W) cooled in the electrical component module (150) from the fourth cooling water passage (234) through the second cooling water passage (232) to the second refrigerant-to-cooling water heat exchanger (124), increasing the thermal of the second refrigerant-to-cooling water heat exchanger (124).

Meanwhile, the inefficient battery warm-up mode is a mode in which the battery pack (140) is rapidly warmed up while the operation of the air conditioning unit is stopped. This mode utilizes the residual heat of the cooling water that has heated the battery pack (140) and the electrical component module (150) for heating and warming. The inefficient battery warm-up mode may be implemented when the interior heating reaches a certain level.

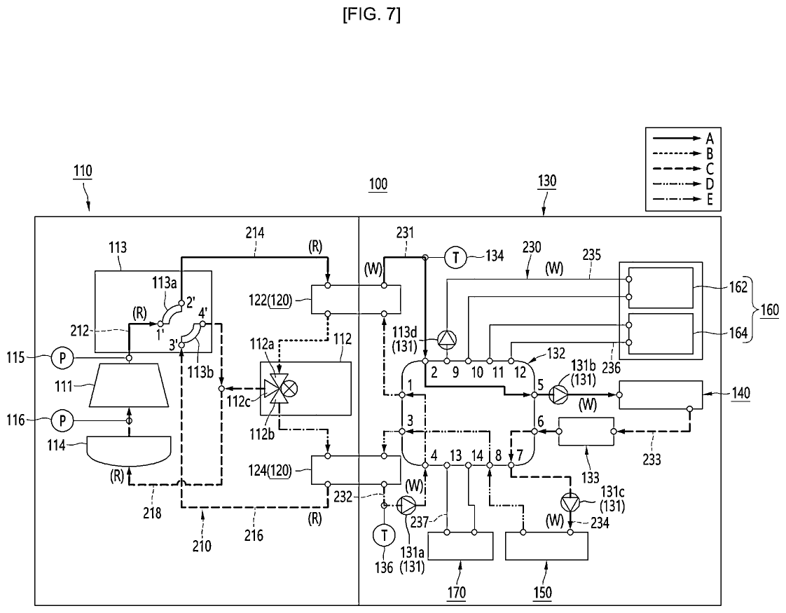

FIG. 7 illustrates an inefficient battery warm-up drying mode of the first thermal management mode of the thermal management system (100) shown in FIG. 1.

As illustrated in FIG. 7, the inefficient battery warm-up drying mode is performed under environmental conditions where the operation of the air conditioning unit is unnecessary. In this mode, the thermal of the battery pack (140) and the electrical component module (150) may be increased by using the high-thermal cooling water (W) heated by the first refrigerant-to-cooling water heat exchanger (122), and the cooling water (W) that has increased the thermal of the battery pack (140) and the electrical component module (150) may be cooled by the second refrigerant-to-cooling water heat exchanger (124). In addition, the inefficient battery warm-up drying mode is similar to the inefficient battery warm-up mode illustrated in FIG. 6, but differs in that a portion of the refrigerant introduced into the expansion valve (112) may be bypassed to the fourth refrigerant passage (218) through the third inlet/outlet port (112c).

Here, the cooling water control valve (132) may deliver the high-thermal cooling water (W) heated by the first refrigerant-to-cooling water heat exchanger (122) from the first cooling water passage (231) through the third cooling water passage (233) to the battery pack (140), increasing the thermal of the battery pack (140). Alternatively, the cooling water control valve (132) may deliver the medium-thermal cooling water (W) cooled in the battery pack (140) from the third cooling water passage (233) through the fourth cooling water passage (234) to the electrical component module (150), increasing the thermal of the electrical component module (150). Additionally, the cooling water control valve (132) may deliver the medium-low-thermal cooling water (W) cooled in the electrical component module (150) from the fourth cooling water passage (234) through the second cooling water passage (232) to the second refrigerant-to-cooling water heat exchanger (124), increasing the thermal of the second refrigerant-to-cooling water heat exchanger (124).

Meanwhile, the inefficient battery warm-up drying mode is a mode in which the battery pack (140) is rapidly warmed up while the operation of the air conditioning unit is stopped. This mode utilizes the residual heat of the cooling water that has heated the battery pack (140) and the electrical component module (150) for heating and warming. However, unlike the inefficient battery warm-up mode, the inefficient battery warm-up drying mode bypasses a portion of the refrigerant introduced into the expansion valve (112) toward the compressor (111), thereby increasing the drying efficiency of the heat pump unit (110), which may otherwise be reduced due to the inefficient battery warm-up.

FIG. 8 illustrates the battery heat storage mode of the second thermal management mode of the thermal management system (100) shown in FIG. 1. The second thermal management mode may include a battery heat storage mode.

As illustrated in FIG. 8, the battery heat storage mode is performed under environmental conditions where the battery pack (140) is heated as a heat source for indoor heating of an electric vehicle when the driver is absent during winter. In this mode, the thermal of the battery pack (140) may be increased using the high-thermal cooling water (W) heated by the first refrigerant-to-cooling water heat exchanger (122), and the low-thermal cooling water (W) cooled by the second refrigerant-to-cooling water heat exchanger (124) may be used as a heat source for indoor heating of the electric vehicle.

Here, the cooling water control valve (132) opens the first and second cooling water ports (1, 2) to allow cooling water (W) to flow through the first cooling water passage (231). It also opens the fifth and sixth cooling water ports (5, 6) to receive the cooling water (W) flowing into the second cooling water port (2) and transfer it to the fifth cooling water port (5), allowing the cooling water (W) to flow through the third cooling water passage (233) before transferring the cooling water (W) flowing into the sixth cooling water port (6) to the first cooling water port (1).

Additionally, the cooling water control valve (132) opens the seventh and eighth cooling water ports (7, 8) to allow cooling water (W) to flow through the fourth cooling water passage (234), and opens the thirteenth and fourteenth cooling water ports (13, 14) to receive the cooling water (W) flowing into the eighth cooling water port (8) and transfer it to the thirteenth cooling water port (13), allowing the cooling water (W) to flow through the seventh cooling water passage (237) before transferring the cooling water (W) flowing into the fourteenth cooling water port (14) to the seventh cooling water port (7).

Furthermore, the cooling water control valve (132) opens the third and fourth cooling water ports (3, 4) to allow cooling water (W) to flow through the second cooling water passage (232), and opens the eleventh and twelfth cooling water ports (11, 12) to receive the cooling water (W) flowing into the fourth cooling water port (4) and transfer it to the eleventh cooling water port (11), allowing the cooling water (W) to flow through the sixth cooling water passage (236) before transferring the cooling water (W) flowing into the twelfth cooling water port (12) to the third cooling water port (3).

Here, the cooling water control valve (132) may deliver the high-thermal cooling water (W) heated by the first refrigerant-to-cooling water heat exchanger (122) from the first cooling water passage (231) through the third cooling water passage (233) to the battery pack (140), increasing the thermal of the battery pack (140). The cooling water control valve (132) may deliver the medium-low-thermal cooling water (W) cooled in the radiator (170) from the seventh cooling water passage (237) through the fourth cooling water passage (234) to the electrical component module (150), lowering the thermal of the electrical component module (150). Additionally, the cooling water control valve (132) may deliver the cooling water (W) heat-exchanged with the external air to a medium-low thermal in the radiator (170) from the seventh cooling water passage (237) through the fourth cooling water passage (234) to the electrical component module (150), increasing the thermal of the electrical component module (150).

Meanwhile, the battery heat storage mode is a mode in which the battery pack (140) is heated as a heat source for indoor heating of an electric vehicle when the driver is absent before or after driving in winter. In the battery heat storage mode, only the battery pack (140) may be heated using the indoor heating heat source, while the electrical component module (150) may be cooled by the radiator (170) while being in an inactive state.

Referring to FIGS. 9 to 14, the third thermal management mode may include a waste heat recovery heating mode, a defogging mode, a defrosting mode, a battery warm-up followed by dehumidification mode, a battery warm-up followed by battery cooling air-conditioning mode, and an electrical component warm-up mode.

FIG. 9 illustrates the waste heat recovery heating mode of the third thermal management mode of the thermal management system (100) shown in FIG. 1.

As illustrated in FIG. 9, the waste heat recovery heating mode is performed under environmental conditions aimed at improving the indoor heating performance of an electric vehicle in extreme cold conditions. In this mode, the thermal of the battery pack (140) and the electrical component module (150) may be lowered using the low-thermal cooling water (W) cooled by the first refrigerant-to-cooling water heat exchanger (122), and the thermal of the second cooling water-to-air heat exchanger (164) may be increased using the high-thermal cooling water (W) heated by the second refrigerant-to-cooling water heat exchanger (124).

Here, the cooling water control valve (132) opens the first and second cooling water ports (1, 2) to allow cooling water (W) to flow through the first cooling water passage (231). It also opens the fifth and sixth cooling water ports (5, 6) to receive the cooling water (W) flowing into the second cooling water port (2) and transfer it to the fifth cooling water port (5), allowing the cooling water (W) to flow through the third cooling water passage (233). Additionally, the seventh and eighth cooling water ports (7, 8) are opened to receive the cooling water (W) flowing into the sixth cooling water port (6) and transfer it to the seventh cooling water port (7), allowing the cooling water (W) to flow through the fourth cooling water passage (234) before transferring the cooling water (W) flowing into the eighth cooling water port (8) to the first cooling water port (1).

Furthermore, the cooling water control valve (132) opens the third and fourth cooling water ports (3, 4) to allow cooling water (W) to flow through the second cooling water passage (232). It also opens the eleventh and twelfth cooling water ports (11, 12) to receive the cooling water (W) flowing into the fourth cooling water port (4) and transfer it to the eleventh cooling water port (11), allowing the cooling water (W) to flow through the sixth cooling water passage (236) before transferring the cooling water (W) flowing into the twelfth cooling water port (12) to the third cooling water port (3).

As a result, the cooling water control valve (132) may deliver the low-thermal cooling water (W) cooled by the first refrigerant-to-cooling water heat exchanger (122) from the first cooling water passage (231) through the third cooling water passage (233) to the battery pack (140), lowering the thermal of the battery pack (140). Additionally, the cooling water control valve (132) may deliver the medium-low-thermal cooling water (W) heated in the battery pack (140) from the third cooling water passage (233) through the fourth cooling water passage (234) to the electrical component module (150), lowering the thermal of the electrical component module (150). Furthermore, the cooling water control valve (132) may deliver the medium-thermal cooling water (W) heated in the electrical component module (150) from the fourth cooling water passage (234) through the second cooling water passage (232) to the first refrigerant-to-cooling water heat exchanger (114a), enabling the recovery of waste heat from the battery pack (140) and the electrical component module (150).

Additionally, the cooling water control valve (132) may deliver the high-thermal cooling water (W) heated by the second refrigerant-to-cooling water heat exchanger (124) from the second cooling water passage (232) through the sixth cooling water passage (236) to the second cooling water-to-air heat exchanger (164), increasing the thermal of the second cooling water-to-air heat exchanger (164).

Meanwhile, the waste heat recovery heating mode is a mode that enhances the indoor heating performance of the electric vehicle in extreme cold environments, even when the thermal of the battery pack (140) is low, as long as the battery pack (140) and the electrical component module (150) retain a certain level of waste heat. In the waste heat recovery heating mode, the residual heat from the battery pack (140) and the electrical component module (150) may be used to heat the second cooling water-to-air heat exchanger (164).

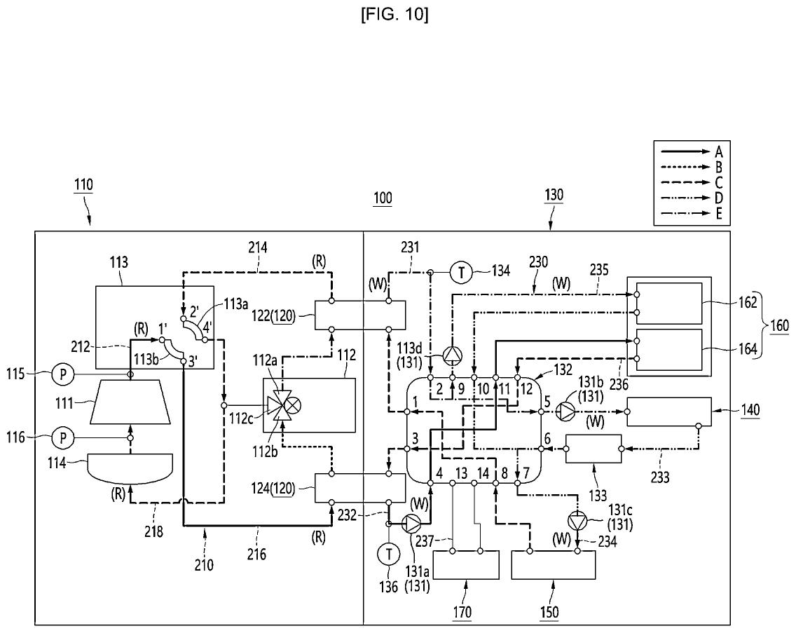

FIG. 10 illustrates the defogging mode of the third thermal management mode of the thermal management system (100) shown in FIG. 1.

As illustrated in FIG. 10, the defogging mode is performed under environmental conditions requiring the removal of fogging. In this mode, the low-thermal cooling water (W) cooled by the first refrigerant-to-cooling water heat exchanger (122) may be used to lower the thermal of the battery pack (140), the first cooling water-to-air heat exchanger (162), and the electrical component module (150), while the high-thermal cooling water (W) heated by the second refrigerant-to-cooling water heat exchanger (124) may be used to raise the thermal of the second cooling water-to-air heat exchanger (164).

Here, the cooling water control valve (132) opens the first and second cooling water ports (1, 2) to allow cooling water (W) to flow through the first cooling water passage (231). It also opens the fifth and sixth cooling water ports (5, 6) to receive the cooling water (W) flowing into the second cooling water port (2) and transfer it to the fifth cooling water port (5), allowing the cooling water (W) to flow through the third cooling water passage (233). Additionally, the ninth and tenth cooling water ports (9, 10) are opened to receive the cooling water (W) flowing into the second cooling water port (2) and transfer it to the ninth cooling water port (9), allowing the cooling water (W) to flow through the fifth cooling water passage (235). The seventh and eighth cooling water ports (7, 8) are opened to receive the cooling water (W) flowing into the sixth and tenth cooling water ports (6, 10) and transfer it to the seventh cooling water port (7), allowing the cooling water (W) to flow through the fourth cooling water passage (234) before transferring the cooling water (W) flowing into the eighth cooling water port (8) to the first cooling water port (1).

Furthermore, the cooling water control valve (132) opens the third and fourth cooling water ports (3, 4) to allow cooling water (W) to flow through the second cooling water passage (232). It also opens the eleventh and twelfth cooling water ports (11, 12) to receive the cooling water (W) flowing into the fourth cooling water port (4) and transfer it to the eleventh cooling water port (11), allowing the cooling water (W) to flow through the sixth cooling water passage (236) before transferring the cooling water (W) flowing into the twelfth cooling water port (12) to the third cooling water port (3).

As a result, the cooling water control valve (132) may deliver the low-thermal cooling water (W) cooled by the first refrigerant-to-cooling water heat exchanger (122) from the first cooling water passage (231) through the third cooling water passage (233) and the fifth cooling water passage (235) to the battery pack (140) and the first cooling water-to-air heat exchanger (162), thereby lowering the thermal of the battery pack (140) and the first cooling water-to-air heat exchanger (162). Additionally, the cooling water control valve (132) may deliver the medium-low-thermal cooling water (W) heated in the battery pack (140) and the first cooling water-to-air heat exchanger (162) from the third cooling water passage (233) through the fourth cooling water passage (234) to the electrical component module (150), lowering the thermal of the electrical component module (150). Furthermore, the cooling water control valve (132) may deliver the medium-thermal cooling water (W) heated in the electrical component module (150) from the fourth cooling water passage (234) through the second cooling water passage (232) to the first refrigerant-to-cooling water heat exchanger (122), enabling the recovery of waste heat from the battery pack (140), the first cooling water-to-air heat exchanger (162), and the electrical component module (150). Additionally, the cooling water control valve (132) may deliver the high-thermal cooling water (W) heated by the second refrigerant-to-cooling water heat exchanger (124) from the second cooling water passage (232) through the sixth cooling water passage (236) to the second cooling water-to-air heat exchanger (164), increasing the thermal of the second cooling water-to-air heat exchanger (164).

Meanwhile, the defogging mode is a mode that removes fogging by collecting and heating moisture contained in the air inside the air conditioning system. In the defogging mode, the low-thermal cooling water (W) cooled by the first cooling water-to-air heat exchanger (162) may be used to collect moisture from the air, and the high-thermal cooling water (W) heated by the second cooling water-to-air heat exchanger (164) may be used to heat the dehumidified air before discharging it toward the glass surfaces of the electric vehicle.

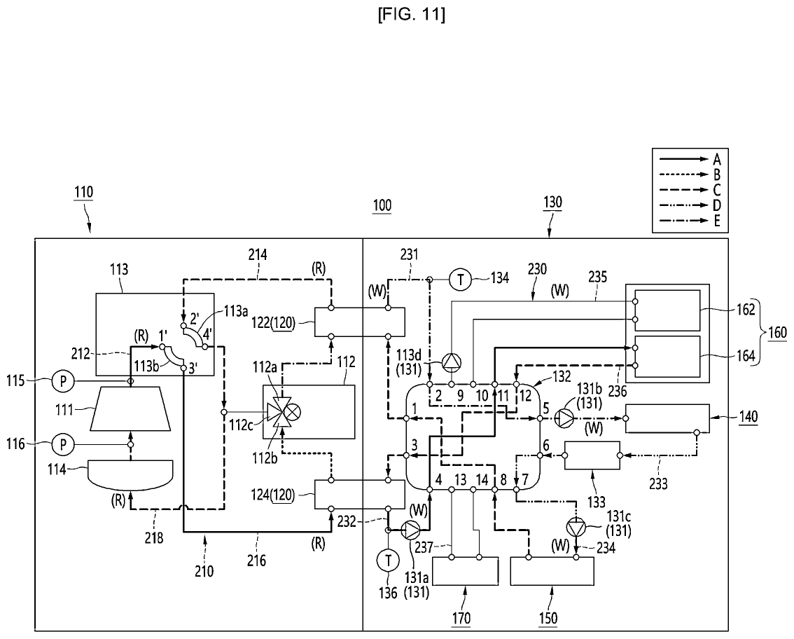

FIG. 11 illustrates the defrosting mode of the third thermal management mode of the thermal management system (100) shown in FIG. 1.

As illustrated in FIG. 11, the defrosting mode is performed under environmental conditions requiring defrosting of the cooling water-to-air heat exchanger (160). In this mode, the low-thermal cooling water (W) cooled by the first refrigerant-to-cooling water heat exchanger (122) may be used to lower the thermal of the battery pack (140) and the electrical component module (150), while the high-thermal cooling water (W) heated by the second refrigerant-to-cooling water heat exchanger (124) may be used to raise the thermal of the second cooling water-to-air heat exchanger (164).

Here, the cooling water control valve (132) opens the first and second cooling water ports (1, 2) to allow cooling water (W) to flow through the first cooling water passage (231). It also opens the fifth and sixth cooling water ports (5, 6) to receive the cooling water (W) flowing into the second cooling water port (2) and transfer it to the fifth cooling water port (5), allowing the cooling water (W) to flow through the third cooling water passage (233). Additionally, the seventh and eighth cooling water ports (7, 8) are opened to receive the cooling water (W) flowing into the sixth cooling water port (6) and transfer it to the seventh cooling water port (7), allowing the cooling water (W) to flow through the fourth cooling water passage (234) before transferring the cooling water (W) flowing into the eighth cooling water port (8) to the first cooling water port (1).

Furthermore, the cooling water control valve (132) opens the third and fourth cooling water ports (3, 4) to allow cooling water (W) to flow through the second cooling water passage (232). It also opens the eleventh and twelfth cooling water ports (11, 12) to receive the cooling water (W) flowing into the fourth cooling water port (4) and transfer it to the eleventh cooling water port (11), allowing the cooling water (W) to flow through the sixth cooling water passage (236) before transferring the cooling water (W) flowing into the twelfth cooling water port (12) to the third cooling water port (3).

As a result, the cooling water control valve (132) may deliver the low-thermal cooling water (W) cooled by the first refrigerant-to-cooling water heat exchanger (122) from the first cooling water passage (231) through the third cooling water passage (233) to the battery pack (140), thereby lowering the thermal of the battery pack (140). Additionally, the cooling water control valve (132) may deliver the medium-low-thermal cooling water (W) heated in the battery pack (140) from the third cooling water passage (233) through the fourth cooling water passage (234) to the electrical component module (150), lowering the thermal of the electrical component module (150). Furthermore, the cooling water control valve (132) may deliver the medium-thermal cooling water (W) heated in the electrical component module (150) from the fourth cooling water passage (234) through the second cooling water passage (232) to the first refrigerant-to-cooling water heat exchanger (122), enabling the recovery of waste heat from the battery pack (140) and the electrical component module (150). Additionally, the cooling water control valve (132) may deliver the high-thermal cooling water (W) heated by the second refrigerant-to-cooling water heat exchanger (124) from the second cooling water passage (232) through the sixth cooling water passage (236) to the second cooling water-to-air heat exchanger (164), increasing the thermal of the second cooling water-to-air heat exchanger (164).

Meanwhile, the defrosting mode is a mode that releases the overcooled state of the first cooling water-to-air heat exchanger (162) in the air conditioning system and corresponds to a state where only the operation of the first cooling water-to-air heat exchanger (162) is stopped in the defogging mode. In the defrosting mode, the operation of the first cooling water-to-air heat exchanger (162) may be stopped to cease moisture collection from the air, and in this state, the second cooling water-to-air heat exchanger (164), heated by high-thermal cooling water (W), may be used to heat the indoor air, thereby removing frost formed on the first cooling water-to-air heat exchanger (162).

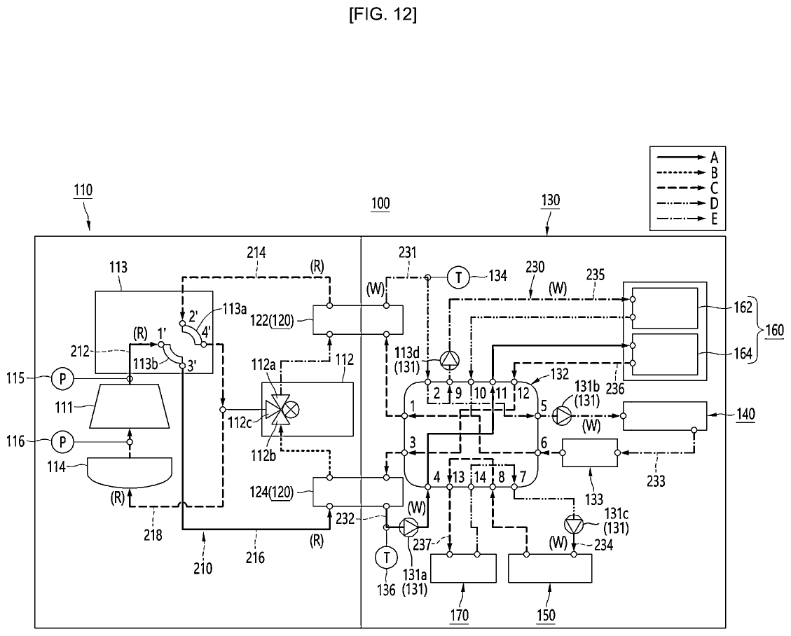

FIG. 12 illustrates the battery warm-up and dehumidification mode of the third thermal management mode of the thermal management system (100) shown in FIG. 1.

As illustrated in FIG. 12, the battery warm-up and dehumidification mode is performed under environmental conditions requiring dehumidification of the indoor air of the electric vehicle. In this mode, the low-thermal cooling water (W) cooled by the first refrigerant-to-cooling water heat exchanger (122) may be used to lower the thermal of the battery pack (140) and the first cooling water-to-air heat exchanger (162), while the high-thermal cooling water (W) heated by the second refrigerant-to-cooling water heat exchanger (124) may be used to raise the thermal of the second cooling water-to-air heat exchanger (164). Accordingly, the moisture collected in the first cooling water-to-air heat exchanger (162) may be removed. However, in the battery warm-up and dehumidification mode, since the battery pack (140) has already been warmed up, the thermal of the battery pack (140) remains at a relatively high level.

Here, the cooling water control valve (132) opens the first and second cooling water ports (1, 2) to allow cooling water (W) to flow through the first cooling water passage (231). It also opens the fifth and sixth cooling water ports (5, 6) to receive the cooling water (W) flowing into the second cooling water port (2) and transfer it to the fifth cooling water port (5), allowing the cooling water (W) to flow through the third cooling water passage (233). Additionally, the ninth and tenth cooling water ports (9, 10) are opened to receive the cooling water (W) flowing into the second cooling water port (2) and transfer it to the ninth cooling water port (9), allowing the cooling water (W) to flow through the fifth cooling water passage (235). Furthermore, the cooling water control valve (132) transfers the cooling water (W) flowing into the sixth and tenth cooling water ports (6, 10) to the first cooling water port (1).

Additionally, the cooling water control valve (132) opens the third and fourth cooling water ports (3, 4) to allow cooling water (W) to flow through the second cooling water passage (232). It also opens the eleventh and twelfth cooling water ports (11, 12) to receive the cooling water (W) flowing into the fourth cooling water port (4) and transfer it to the eleventh cooling water port (11), allowing the cooling water (W) to flow through the sixth cooling water passage (236) before transferring the cooling water (W) flowing into the twelfth cooling water port (12) to the third cooling water port (3).

As a result, the cooling water control valve (132) may deliver the low-thermal cooling water (W) cooled by the first refrigerant-to-cooling water heat exchanger (122) from the first cooling water passage (231) to the battery pack (140) and the first cooling water-to-air heat exchanger (162) through the third cooling water passage (233) and the fifth cooling water passage (235), thereby lowering the thermals of the battery pack (140) and the first cooling water-to-air heat exchanger (162).

Additionally, the cooling water control valve (132) may transfer the medium-thermal cooling water (W) heated by the battery pack (140) and the low-medium thermal cooling water (W) heated by the first cooling water-to-air heat exchanger (162) through the third cooling water passage (233) and the fifth cooling water passage (235) to the first cooling water passage (231) and subsequently to the first refrigerant-to-cooling water heat exchanger (122), thereby recovering waste heat from the battery pack (140) and the first cooling water-to-air heat exchanger (162). Furthermore, the cooling water control valve (132) may transfer the high-thermal cooling water (W) heated by the second refrigerant-to-cooling water heat exchanger (114b) from the second cooling water passage (232) through the sixth cooling water passage (236) to the second cooling water-to-air heat exchanger (164), thereby increasing the thermal of the second cooling water-to-air heat exchanger (164). In addition, the cooling water control valve (132) may transfer the cooling water (W) that has undergone heat exchange with the ambient air at a low-medium thermal in the radiator (170) from the seventh cooling water passage (237) through the fourth cooling water passage (234) to the electrical component module (150), thereby increasing the thermal of the electrical component module (150).

Meanwhile, the battery warm-up and dehumidification mode is a mode that utilizes the residual heat from warming up the battery pack (140) while performing dehumidification when cooling of the battery pack (140) and indoor air is required. In the dehumidification mode, the low-thermal cooling water (W) cooled by the first refrigerant-to-cooling water heat exchanger (122) may be used to collect moisture from the indoor air via the first cooling water-to-air heat exchanger (162) and subsequently cool the battery pack (140). However, the electrical component module (150) may be independently cooled by the radiator (170).

It should be noted that in the battery warm-up and dehumidification mode, since the battery pack (140) has already been warmed up, the thermal of the battery pack (140) may remain at a relatively high level. At this time, since the first cooling water-to-air heat exchanger (162) only needs to reach the dew point thermal, a relatively small amount of cooling water (W) is required for cooling the first cooling water-to-air heat exchanger (162), whereas the battery pack (140), being in a warmed-up state at a high thermal, requires a relatively larger flow rate for cooling. However, the amount of cooling water (W) discharged from the battery pack (140) is greater than the amount of cooling water (W) discharged from the first cooling water-to-air heat exchanger (162). Additionally, the cooling water (W) flowing from the battery pack (140) to the first refrigerant-to-cooling water heat exchanger (122) may be appropriately heated to the desired thermal while passing through the cooling water heater (133).

For reference, a more detailed explanation of the thermal variations of the cooling water (W) depending on whether the battery pack (140) has been warmed up is as follows:

First, the output of the second cooling water pump (131b) installed in the third cooling water passage (233) may be varied depending on the thermal state of the battery pack (140). At this time, the flow rate ratio of the cooling water (W) flowing to the battery pack (140) and the first cooling water-to-air heat exchanger (162) may be adjusted based on the output ratio of the second cooling water pump (131b) installed in the third cooling water passage (233) and the fourth cooling water pump (131d) installed in the fifth cooling water passage (235). However, in the battery warm-up and dehumidification mode, since cooling is performed to maintain the optimal thermal after the battery pack (140) has been warmed up, the output of the second cooling water pump (131b) may be increased. Consequently, due to the increased flow rate of cooling water (W), more heat may be absorbed from the cooling water (W) passing through the battery pack (140), thereby accelerating the cooling of the battery pack (140).

In this state, the first cooling water-to-air heat exchanger (162) may adjust the pump output of the fourth cooling water pump (131d) installed in the fifth cooling water passage (235) to maintain a thermal below the dew point, which varies depending on the ambient thermal, the indoor thermal, and the output of the blower that introduces air into the air-conditioning system.

As described above, the cooling water flow rates in the third cooling water passage (233) and the fifth cooling water passage (235), which are adjusted by the second cooling water pump (131b) and the fourth cooling water pump (131d), respectively, may be merged by the cooling water control valve (132) and supplied to the first refrigerant-to-cooling water heat exchanger (122) through the first cooling water passage (231). At this time, the thermal of the cooling water (W) merged in the first cooling water passage (231) may be determined by the flow rates and thermals of the cooling water (W) flowing through the third cooling water passage (233) and the fifth cooling water passage (235).

Therefore, before the warm-up of the battery pack (140), the thermal of the battery pack (140) may be increased by either stopping the operation of the second cooling water pump (131b) or operating it at a low output. After the warm-up of the battery pack (140), the thermal rise of the battery pack (140) may be prevented by increasing the output of the second cooling water pump (131b). Generally, before the warm-up of the battery pack (140), since the flow rate and thermal of the cooling water (W) passing through the first cooling water-to-air heat exchanger (162) are high, the thermal of the cooling water (W) merged in the first cooling water passage (231) is significantly influenced by the cooling water (W) in the fifth cooling water passage (235). Conversely, after the warm-up of the battery pack (140), since the flow rate and thermal of the cooling water (W) passing through the battery pack (140) are high, the thermal of the cooling water (W) merged in the first cooling water passage (231) is significantly influenced by the cooling water in the third cooling water passage (233).

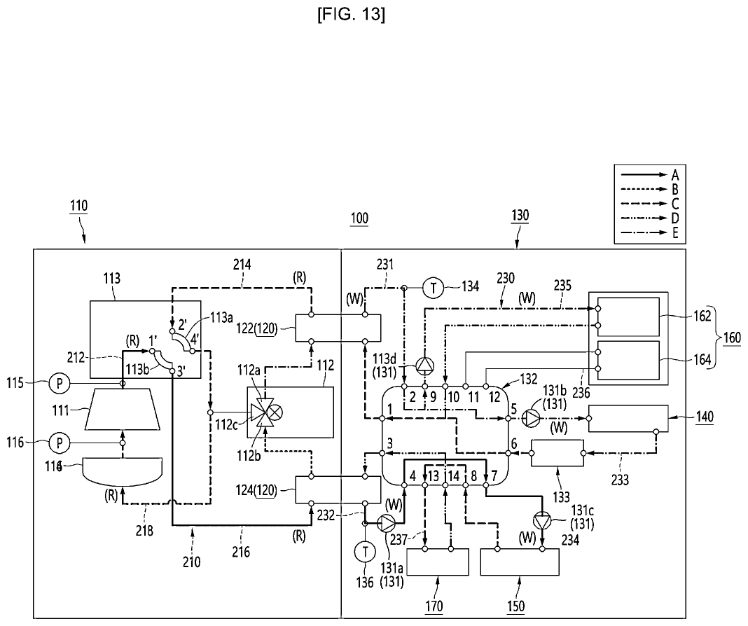

FIG. 13 illustrates the battery cooling air-conditioning mode after battery warm-up in the third thermal management mode of the thermal management system (100) shown in FIG. 1.

As shown in FIG. 13, the battery cooling air-conditioning mode after battery warm-up is performed by using the low-thermal cooling water (W) cooled by the first refrigerant-to-cooling water heat exchanger (122) to lower the thermals of the battery pack (140) and the first cooling water-to-air heat exchanger (162), while the high-thermal cooling water (W) heated by the second refrigerant-to-cooling water heat exchanger (124) is supplied to the electrical component module (150) and then cooled through the radiator (170).

Here, the cooling water control valve (132) opens the first and second cooling water ports (1, 2) to allow the cooling water (W) to flow through the first cooling water passage (231), opens the fifth and sixth cooling water ports (5, 6) to direct the cooling water (W) introduced into the second cooling water port (2) to the fifth cooling water port (5) and into the third cooling water passage (233), opens the ninth and tenth cooling water ports (9, 10) to direct the cooling water (W) introduced into the second cooling water port (2) to the ninth cooling water port (9) and into the fifth cooling water passage (235), and allows the cooling water (W) introduced into the sixth and tenth cooling water ports (6, 10) to be directed to the first cooling water port (1).

Additionally, the cooling water control valve (132) opens the third and fourth cooling water ports (3, 4) to allow the cooling water (W) to flow through the second cooling water passage (232), opens the seventh and eighth cooling water ports (7, 8) to direct the cooling water (W) introduced into the fourth cooling water port (4) to the seventh cooling water port (7) and into the fourth cooling water passage (234), and opens the thirteenth and fourteenth cooling water ports (13, 14) to direct the cooling water (W) introduced into the eighth cooling water port (8) to the thirteenth cooling water port (13) and into the seventh cooling water passage (237), before allowing the cooling water (W) introduced into the fourteenth cooling water port (14) to be directed to the third cooling water port (3).

As a result, the cooling water control valve (132) delivers the low-thermal cooling water (W) cooled by the first refrigerant-to-cooling water heat exchanger (122) from the first cooling water passage (231) through the third cooling water passage (233) and the fifth cooling water passage (235) to the battery pack (140) and the first cooling water-to-air heat exchanger (162), thereby lowering the thermals of the battery pack (140) and the first cooling water-to-air heat exchanger (162). Additionally, the cooling water control valve (132) transfers the cooling water (W) heated to a medium thermal at the battery pack (140) and the cooling water (W) heated to a sub-medium thermal at the first cooling water-to-air heat exchanger (162) from the third cooling water passage (233) and the fifth cooling water passage (235) through the first cooling water passage (231) to the first refrigerant-to-cooling water heat exchanger (122) for heat recovery from the battery pack (140) and the first cooling water-to-air heat exchanger (162). Furthermore, the cooling water control valve (132) delivers the high-thermal cooling water (W) heated by the second refrigerant-to-cooling water heat exchanger (124) from the second cooling water passage (232) through the fourth cooling water passage (234) to the electrical component module (150) to raise its thermal. The cooling water control valve (132) also transfers the cooling water (W) cooled to a medium thermal at the electrical component module (150) from the fourth cooling water passage (234) through the seventh cooling water passage (237) to the radiator (170) to cool the cooling water to a low thermal, before supplying it to the second refrigerant-to-cooling water heat exchanger (114b) via the second cooling water passage (232).

Meanwhile, the battery cooling air-conditioning mode after battery warm-up is a mode in which residual heat generated by warming up the battery pack (140) is utilized to cool the interior air and the battery pack (140). In this cooling air-conditioning mode, low-thermal cooling water may cool the battery pack (140) and the first cooling water-to-air heat exchanger (162), while the electrical component module (150) may be cooled using the radiator (170).

However, similar to the dehumidification mode after battery warm-up, in the battery cooling air-conditioning mode after battery warm-up, the battery pack (140) remains at a relatively high thermal after being warmed up. Additionally, because the amount of cooling water (W) discharged from the battery pack (140) is greater than the amount of cooling water (W) discharged from the first cooling water-to-air heat exchanger (162), the thermal of the cooling water (W) flowing into the first refrigerant-to-cooling water heat exchanger (122) may change to a medium thermal due to the influence of the cooling water (W) discharged from the battery pack (140). However, as the cooling water (W) flows from the battery pack (140) to the first refrigerant-to-cooling water heat exchanger (122), it may be heated to an appropriate thermal by passing through the cooling water heater (133).

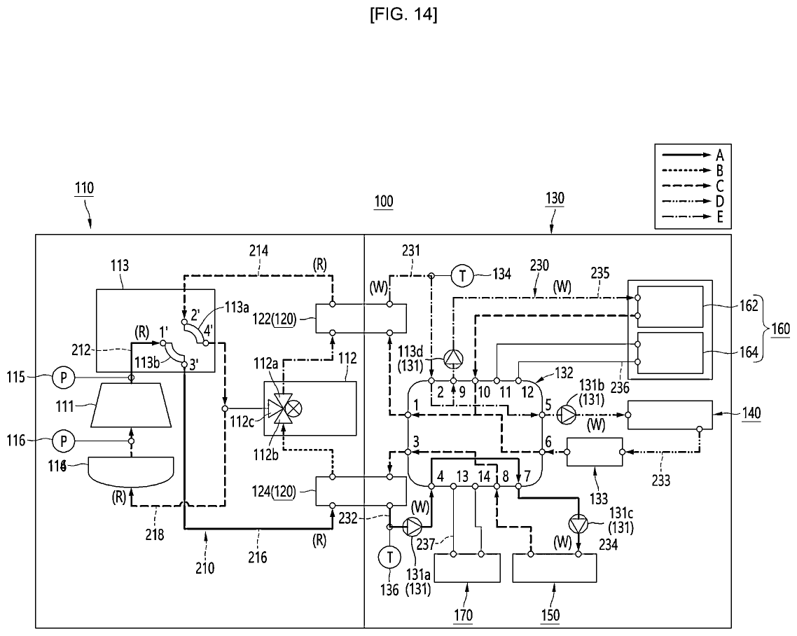

FIG. 14 illustrates an electrical component warm-up cooling mode of the third thermal management mode of the thermal management system (100) shown in FIG. 1.

As illustrated in FIG. 14, the electrical component warm-up cooling mode is performed in environmental conditions where rapid warm-up of the electrical component module (150) is required. In this mode, the thermal of the battery pack (140) and the first cooling water-to-air heat exchanger (162) may be lowered by using low-thermal cooling water (W) cooled by the first refrigerant-to-cooling water heat exchanger (122), while the thermal of the electrical component module (150) may be increased by using high-thermal cooling water (W) heated by the second refrigerant-to-cooling water heat exchanger (124).

Here, the cooling water control valve (132) opens the first and second cooling water ports (1, 2) to allow cooling water (W) to flow through the first cooling water passage (231), and opens the fifth and sixth cooling water ports (5, 6) to receive the cooling water (W) introduced into the second cooling water port (2) and direct it to the third cooling water passage (233) via the fifth cooling water port (5). The ninth and tenth cooling water ports (9, 10) are opened to direct the cooling water (W) introduced into the second cooling water port (2) to the fifth cooling water passage (235) via the ninth cooling water port (9), while the cooling water (W) introduced into the sixth and tenth cooling water ports (6, 10) is directed to the first cooling water port (1).

Additionally, the cooling water control valve (132) opens the third and fourth cooling water ports (3, 4) to allow cooling water (W) to flow through the second cooling water passage (232), and opens the seventh and eighth cooling water ports (7, 8) to direct the cooling water (W) introduced into the fourth cooling water port (4) to the fourth cooling water passage (234) via the seventh cooling water port (7), then directs the cooling water (W) introduced into the eighth cooling water port (8) back to the third cooling water port (3).

As a result, the cooling water control valve (132) may transfer low-thermal cooling water (W) cooled by the first refrigerant-to-cooling water heat exchanger (122) from the first cooling water passage (231) through the third cooling water passage (233) and the fifth cooling water passage (235) to the battery pack (140) and the first cooling water-to-air heat exchanger (162), thereby lowering their thermals. Furthermore, the cooling water control valve (132) may supply high-thermal cooling water (W) heated by the second refrigerant-to-cooling water heat exchanger (124) from the second cooling water passage (232) through the fourth cooling water passage (234) to the electrical component module (150), increasing its thermal before directing it back to the second refrigerant-to-cooling water heat exchanger (124) through the second cooling water passage (232).

Meanwhile, the electrical component warm-up cooling mode is a mode designed to rapidly warm up the electrical component module (150) to an optimal preset thermal. In this mode, high-thermal cooling water heated by the second refrigerant-to-cooling water heat exchanger (124) may directly and rapidly heat the electrical component module (150). Additionally, the cooling water (W) flowing from the battery pack (140) to the first refrigerant-to-cooling water heat exchanger (122) may be heated to an appropriate thermal as it passes through the cooling water heater (133).

Referring to FIGS. 15 to 17, the fourth thermal management mode may include a charging cooling mode, a pre-battery warm-up dehumidification mode, and a pre-battery warm-up battery cooling mode.

FIG. 15 illustrates the charging cooling mode of the fourth thermal management mode in the thermal management system (100) shown in FIG. 1.

As illustrated in FIG. 15, the charging cooling mode is performed in an environment where the battery pack (140) undergoes high-power charging in the absence of occupants. In this mode, the thermal of the battery pack (140) may be lowered using low-thermal cooling water (W) cooled by the first refrigerant-to-cooling water heat exchanger (122). Additionally, high-thermal cooling water (W) heated by the second refrigerant-to-cooling water heat exchanger (124) may be used to heat the electrical component module (150) before further lowering the thermal of the cooling water (W) via the radiator (170).

Here, the cooling water control valve (132) opens the first and second cooling water ports (1, 2) to allow cooling water (W) to flow through the first cooling water passage (231). The fifth and sixth cooling water ports (5, 6) are also opened to receive the cooling water (W) introduced into the second cooling water port (2), directing it to the third cooling water passage (233) via the fifth cooling water port (5), after which the cooling water (W) introduced into the sixth cooling water port (6) is directed to the first cooling water port (1).

Additionally, the cooling water control valve (132) opens the third and fourth cooling water ports (3, 4) to allow cooling water (W) to flow through the second cooling water passage (232). The seventh and eighth cooling water ports (7, 8) are opened to direct the cooling water (W) introduced into the fourth cooling water port (4) to the fourth cooling water passage (234) via the seventh cooling water port (7). The thirteenth and fourteenth cooling water ports (13, 14) are opened to direct the cooling water (W) introduced into the eighth cooling water port (8) to the seventh cooling water passage (237) via the thirteenth cooling water port (13), after which the cooling water (W) introduced into the fourteenth cooling water port (14) is directed to the third cooling water port (3).

As a result, the cooling water control valve (132) may transfer low-thermal cooling water (W) cooled by the first refrigerant-to-cooling water heat exchanger (122) from the first cooling water passage (231) through the third cooling water passage (233) to the battery pack (140), thereby lowering its thermal. Additionally, the cooling water control valve (132) may transfer high-thermal cooling water (W) heated by the second refrigerant-to-cooling water heat exchanger (124) from the second cooling water passage (232) through the fourth cooling water passage (234) to the electrical component module (150), increasing its thermal before directing the medium-thermal cooling water (W) discharged from the electrical component module (150) through the fourth cooling water passage (234) to the seventh cooling water passage (237) for heat exchange via the radiator (170). Moreover, the cooling water control valve (132) may transfer the low-thermal cooling water (W) heat-exchanged through the radiator (170) from the seventh cooling water passage (237) through the second cooling water passage (232) to the second refrigerant-to-cooling water heat exchanger (114b).

Meanwhile, the charging cooling mode is a mode that allows the battery pack (140) to undergo stable high-power charging while the air conditioning system is deactivated in the absence of occupants. In this mode, low-thermal cooling water (W) cooled by the first refrigerant-to-cooling water heat exchanger (122) may be used to cool only the battery pack (140), while high-thermal cooling water (W) heated by the second refrigerant-to-cooling water heat exchanger (124) may be used to heat the electrical component module (150) before further cooling it via the radiator (170).

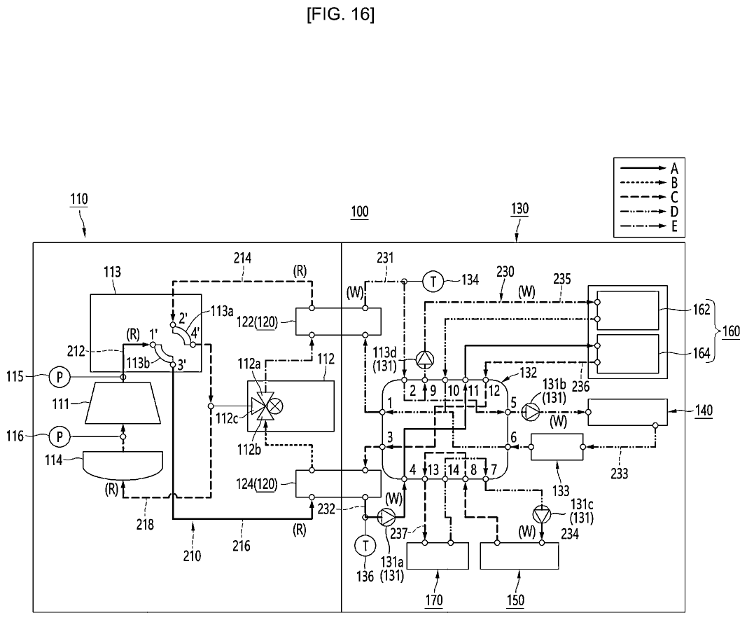

FIG. 16 illustrates the pre-battery warm-up dehumidification mode of the fourth thermal management mode in the thermal management system (100) shown in FIG. 1.

As illustrated in FIG. 16, the pre-battery warm-up dehumidification mode is performed in an environment where dehumidification of the cabin air in an electric vehicle is required. In this mode, the thermal of the battery pack (140) and the first cooling water-to-air heat exchanger (162) may be lowered using low-thermal cooling water (W) cooled by the first refrigerant-to-cooling water heat exchanger (122). Additionally, high-thermal cooling water (W) heated by the second refrigerant-to-cooling water heat exchanger (124) may be used to raise the thermal of the second cooling water-to-air heat exchanger (164), thereby removing the moisture collected in the first cooling water-to-air heat exchanger (162). However, unlike the post-battery warm-up dehumidification mode shown in FIG. 12, the pre-battery warm-up dehumidification mode is performed before the battery pack (140) has been warmed up, meaning that the thermal of the battery pack (140) remains at a lower level.

In the pre-battery warm-up dehumidification mode, the cooling water control valve (132) operates in a manner similar to the post-battery warm-up dehumidification mode shown in FIG. 12, and accordingly, the cooling water (W) flow pattern in the cooling water circulation passage (230) appears nearly identical to that of the post-battery warm-up dehumidification mode illustrated in FIG. 12. Below, the explanation will focus on the differences between the pre-battery warm-up dehumidification mode and the post-battery warm-up dehumidification mode depicted in FIG. 12.

First, in the pre-battery warm-up dehumidification mode, since the thermal of the battery pack (140) is low, the cooling water (W) delivered from the battery pack (140) to the first refrigerant-to-cooling water heat exchanger (122) is at a medium-low thermal. That is, the cooling water control valve (132) transfers cooling water (W) heated to a medium-low thermal in the battery pack (140) and the first cooling water-to-air heat exchanger (162) from the third cooling water passage (233) and the fifth cooling water passage (235) to the first cooling water passage (231), thereby delivering it to the first refrigerant-to-cooling water heat exchanger (122) to recover waste heat from the battery pack (140) and the first cooling water-to-air heat exchanger (162). However, unlike the post-battery warm-up dehumidification mode shown in FIG. 12, since the thermal of the battery pack (140) is low, the amount of recovered waste heat is relatively small.

Meanwhile, the pre-battery warm-up dehumidification mode is used to dehumidify while utilizing residual heat from the battery pack (140) in an environment where cooling of the battery pack (140) and cabin air is required. However, unlike the post-battery warm-up dehumidification mode shown in FIG. 12, the second cooling water pump (131b) is either deactivated or operated at a low output, resulting in a significantly lower flow rate of cooling water (W) supplied to the battery pack (140). Consequently, in the pre-battery warm-up dehumidification mode, since the flow rate of cooling water (W) used for cooling the battery pack (140) is lower than that used for cooling the first cooling water-to-air heat exchanger (162), the thermal of the cooling water (W) delivered to the first refrigerant-to-cooling water heat exchanger (122) is maintained at a medium-low thermal based on the thermal of the cooling water (W) discharged from the first cooling water-to-air heat exchanger (162).

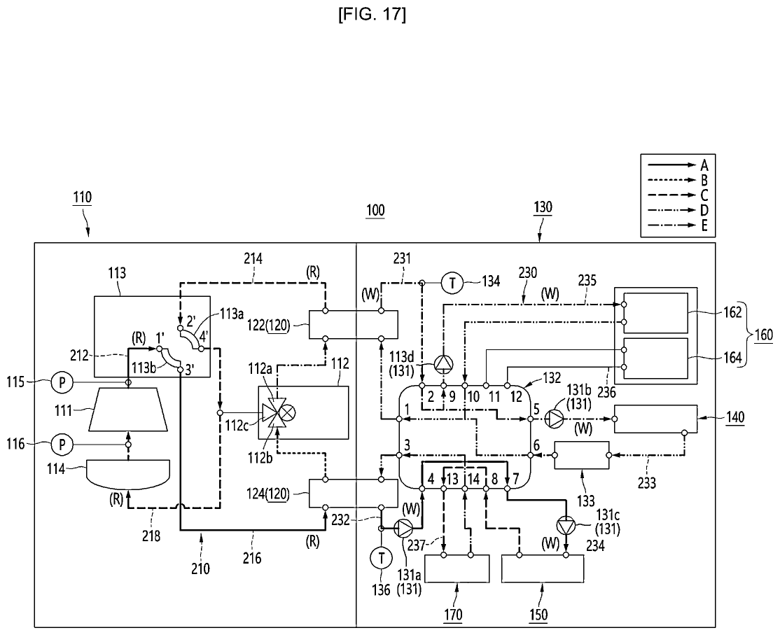

FIG. 17 illustrates the pre-battery warm-up battery cooling air-conditioning mode of the fourth thermal management mode in the thermal management system (100) shown in FIG. 1.

As illustrated in FIG. 17, the pre-battery warm-up battery cooling air-conditioning mode operates in a manner nearly identical to the post-battery warm-up battery cooling air-conditioning mode shown in FIG. 13. Accordingly, the flow pattern of cooling water (W) in the cooling water circulation passage (230) appears nearly identical to that of the post-battery warm-up battery cooling air-conditioning mode illustrated in FIG. 13. Below, the explanation will focus on the differences between the pre-battery warm-up battery cooling air-conditioning mode and the post-battery warm-up battery cooling air-conditioning mode depicted in FIG. 13.

First, in the pre-battery warm-up battery cooling air-conditioning mode, since the thermal of the battery pack (140) is low, the cooling water (W) delivered from the battery pack (140) to the first refrigerant-to-cooling water heat exchanger (122) is at a medium-low thermal. That is, the cooling water control valve (132) transfers cooling water (W) heated to a medium-low thermal in the battery pack (140) and the first cooling water-to-air heat exchanger (162) from the third cooling water passage (233) and the fifth cooling water passage (235) to the first cooling water passage (231), thereby delivering it to the first refrigerant-to-cooling water heat exchanger (122) to partially recover waste heat from the battery pack (140) and the first cooling water-to-air heat exchanger (162). However, unlike the post-battery warm-up battery cooling air-conditioning mode shown in FIG. 13, since the thermal of the battery pack (140) is low, the amount of recovered waste heat is relatively small.

Meanwhile, the pre-battery warm-up battery cooling air-conditioning mode is used to cool the cabin air and the battery pack (140) while utilizing residual heat from the battery pack (140). However, unlike the post-battery warm-up battery cooling air-conditioning mode shown in FIG. 13, the second cooling water pump (131b) is either deactivated or operated at a low output, resulting in a significantly lower flow rate of cooling water supplied to the battery pack (140). Consequently, in the pre-battery warm-up battery cooling air-conditioning mode, since the flow rate of cooling water (W) used for cooling the battery pack (140) is lower than that used for cooling the first cooling water-to-air heat exchanger (162), the thermal of the cooling water (W) delivered to the first refrigerant-to-cooling water heat exchanger (122) is maintained at a medium-low thermal based on the thermal of the cooling water (W) discharged from the first cooling water-to-air heat exchanger (162).

As described above, in the embodiments of the present invention, specific details such as concrete components, limited embodiments, and drawings have been provided for a better overall understanding of the invention. However, the present invention is not limited to the above-described embodiments, and various modifications and variations may be made by those skilled in the art based on the disclosures herein. Accordingly, the spirit of the present invention should not be construed as being limited to the described embodiments, and all equivalents or modifications that are equivalent to or fall within the scope of the claims set forth below shall be considered to fall within the scope of the inventive concept of the present invention.

1. A thermal management system for an electric vehicle, comprising:
a heat pump unit configured to release and absorb heat based on the heat dissipation and condensation heat of a refrigerant;
a refrigerant-to-cooling water heat exchanger having a first side thermally connected to the heat pump unit to be cooled or heated by the refrigerant of the heat pump unit; and
a thermal management unit thermally connected to a second side of the refrigerant-to-cooling water heat exchanger, the thermal management unit being configured to regulate a thermal of at least one of a battery pack and an electrical component by using cooling water that is cooled or heated by the refrigerant-to-cooling water heat exchanger,
wherein the heat pump unit comprises:
a compressor configured to compress the refrigerant;
an expansion valve configured to expand the refrigerant compressed by the compressor;
a refrigerant switching valve disposed between the expansion valve and the compressor and configured to selectively switch a flow direction of the refrigerant flowing between the expansion valve and the compressor; and
a refrigerant circulation passage configured to circulate the refrigerant along the compressor, the refrigerant switching valve, the expansion valve, and the refrigerant-to-cooling water heat exchanger,
wherein the refrigerant circulation passage comprises:
a first refrigerant passage connecting an outlet of the compressor to a first refrigerant port of the refrigerant switching valve;
a second refrigerant passage connecting a second refrigerant port of the refrigerant switching valve to a first inlet/outlet of the expansion valve;
a third refrigerant passage connecting a second inlet/outlet of the expansion valve to a third refrigerant port of the refrigerant switching valve; and
a fourth refrigerant passage connecting a fourth refrigerant port of the refrigerant switching valve to an inlet of the compressor,
wherein the expansion valve comprises:
a first inlet/outlet connected to the second refrigerant passage;
a second inlet/outlet connected to the third refrigerant passage; and
a third inlet/outlet connected to the fourth refrigerant passage,
wherein the first inlet/outlet and the second inlet/outlet are continuously open, and the third inlet/outlet is configured to be selectively opened or closed to bypass a portion of the refrigerant introduced into the expansion valve to the fourth refrigerant passage.

2. The thermal management system of claim 1, wherein the refrigerant-to-cooling water heat exchanger comprises:
a first refrigerant-to-cooling water heat exchanger having one side connected to the second refrigerant passage; and
a second refrigerant-to-cooling water heat exchanger having one side connected to the third refrigerant passage,
wherein one of the first refrigerant-to-cooling water heat exchanger and the second refrigerant-to-cooling water heat exchanger is heated by the refrigerant, and the other one of the first refrigerant-to-cooling water heat exchanger and the second refrigerant-to-cooling water heat exchanger is cooled by the refrigerant.

3. The thermal management system of claim 2, wherein the refrigerant switching valve is a four-way switching valve having a first refrigerant port, a second refrigerant port, a third refrigerant port, and a fourth refrigerant port,
wherein the heat pump unit is configured to operate in one of a first refrigerant flow mode or a second refrigerant flow mode according to an operation pattern of the refrigerant switching valve,
wherein, in the first refrigerant flow mode, the first refrigerant-to-cooling water heat exchanger receives the refrigerant compressed by the compressor, and the second refrigerant-to-cooling water heat exchanger receives the refrigerant expanded by the expansion valve, and
wherein, in the second refrigerant flow mode, the first refrigerant-to-cooling water heat exchanger receives the refrigerant expanded by the expansion valve, and the second refrigerant-to-cooling water heat exchanger receives the refrigerant compressed by the compressor.

4. The thermal management system of claim 3, wherein the refrigerant switching valve further comprises:
a first internal passage configured to selectively connect the first refrigerant port to either the second refrigerant port or the third refrigerant port; and
a second internal passage configured to selectively connect the fourth refrigerant port to either the second refrigerant port or the third refrigerant port,
wherein, in the first refrigerant flow mode, the first internal passage connects the first refrigerant port to the second refrigerant port, and the second internal passage connects the fourth refrigerant port to the third refrigerant port, and
wherein, in the second refrigerant flow mode, the first internal passage connects the first refrigerant port to the third refrigerant port, and the second internal passage connects the fourth refrigerant port to the second refrigerant port.

5. The thermal management system of claim 3, wherein the heat pump unit further comprises:
an accumulator disposed on the fourth refrigerant passage and configured to maintain a constant pressure of the refrigerant flowing into an inlet of the compressor;
a first pressure sensor disposed on the first refrigerant passage and configured to measure a pressure of the refrigerant discharged from an outlet of the compressor; and
a second pressure sensor disposed on the fourth refrigerant passage and configured to measure a pressure of the refrigerant flowing into the inlet of the compressor.

6. The thermal management system of claim 3, further comprising:
a radiator configured to exchange heat between the cooling water and external air; and
a cooling water-to-air heat exchanger configured to exchange heat between the cooling water and interior air of an electric vehicle,
wherein the cooling water-to-air heat exchanger comprises a first cooling water-to-air heat exchanger and a second cooling water-to-air heat exchanger, which are provided to independently control the interior air.

7. The thermal management system of claim 6, wherein the thermal management unit comprises:
a cooling water pump configured to pump the cooling water;
a cooling water heater configured to selectively heat the cooling water;
a cooling water circulation passage configured to circulate the cooling water along the cooling water pump, the cooling water heater, the refrigerant-to-cooling water heat exchanger, the battery pack, the electrical component module, the radiator, and the cooling water-to-air heat exchanger; and
a cooling water control valve disposed on the cooling water circulation passage and configured to change a flow pattern of the cooling water flowing along the cooling water circulation passage, the cooling water control valve being operable in a plurality of operation patterns to regulate thermals of the battery pack, the electrical component module, and the cooling water-to-air heat exchanger.

8. The thermal management system of claim 7, wherein the cooling water circulation passage comprises:
a first cooling water passage configured to connect a first cooling water port and a second cooling water port of the cooling water control valve, and to be connected to a second side of the first refrigerant-to-cooling water heat exchanger;
a second cooling water passage configured to connect a third cooling water port and a fourth cooling water port of the cooling water control valve, and to be connected to a second side of the second refrigerant-to-cooling water heat exchanger;
a third cooling water passage configured to connect a fifth cooling water port and a sixth cooling water port of the cooling water control valve, and to be connected to the battery pack and the cooling water heater;
a fourth cooling water passage configured to connect a seventh cooling water port and an eighth cooling water port of the cooling water control valve, and to be connected to the electrical component module;
a fifth cooling water passage configured to connect a ninth cooling water port and a tenth cooling water port of the cooling water control valve, and to be connected to the first cooling water-to-air heat exchanger;
a sixth cooling water passage configured to connect an eleventh cooling water port and a twelfth cooling water port of the cooling water control valve, and to be connected to the second cooling water-to-air heat exchanger; and
a seventh cooling water passage configured to connect a thirteenth cooling water port and a fourteenth cooling water port of the cooling water control valve, and to be connected to the radiator.

9. The thermal management system of claim 8, wherein the thermal management unit further comprises:
a first thermal sensor disposed on the first cooling water passage and configured to measure a thermal of the cooling water flowing from the first refrigerant-to-cooling water heat exchanger to the second cooling water port; and
a second thermal sensor disposed on the second cooling water passage and configured to measure a thermal of the cooling water flowing from the second refrigerant-to-cooling water heat exchanger to the fourth cooling water port.

10. The thermal management system of claim 8, wherein the cooling water pump comprises:
a first cooling water pump disposed on the second cooling water passage between the second refrigerant-to-cooling water heat exchanger and the fourth cooling water port, and configured to pump the cooling water to the fourth cooling water port;
a second cooling water pump disposed on the third cooling water passage between the fifth cooling water port and the battery pack, and configured to pump the cooling water to the battery pack;
a third cooling water pump disposed on the fourth cooling water passage between the seventh cooling water port and the electrical component module, and configured to pump the cooling water to the electrical component module; and
a fourth cooling water pump disposed on the fifth cooling water passage between the ninth cooling water port and the first cooling water-to-air heat exchanger, and configured to pump the cooling water to the first cooling water-to-air heat exchanger.
